(19) United States
(12) Patent Application Publication
(10) Pub. No.: US 2026/0193037 A1
(43) Pub. Date: Jul. 9, 2026

(54) HANDLING METHOD, HANDLING DEVICE AND WAREHOUSING SYSTEM

(71) Applicant: BEIJING GEEKPLUS TECHNOLOGY CO., LTD., Beijing (CN)

(72) Inventor: Junyi XIAO, Beijing (CN)

(21) Appl. No.: 19/444,344

(22) Filed: Jan. 9, 2026

(30) Foreign Application Priority Data
Jan. 9, 2025 (CN) 202510038440.4
Jan. 9, 2025 (CN) 202520053168.2

(51) Int. Cl. B65G 1/137

(52) U.S. Cl. CPC B65G 1/1373; B65G 2203/0233; B65G 2203/0258

(57) ABSTRACT

A handling method includes: determining cargo information of a target object, wherein the cargo information of the target object includes at least one of dimension information, weight information, or shape information of the target object; determining a target handling device for handling the target object, in which the target motion parameter includes at least one of a motion state of the pick-and-place mechanism, a motion direction of the pick-and-place mechanism, and a number of turns of the pick-and-place mechanism; and controlling, according to the target motion parameter, the pick-and-place mechanism of the target handling device to receive or deliver the target object.

### CROSS REFERENCE OF RELATED APPLICATIONS

The present application claims a priority to Chinese Patent Application No. 202510038440.4, filed on Jan. 9, 2025, and Chinese Patent Application No. 202520053168.2, filed on Jan. 9, 2025, the entire disclosures of which are hereby incorporated herein by reference.

### FIELD

The present disclosure relates to the field of warehousing and logistics technology, and in particular relates to a handling method, a handling device and a warehousing system.

### BACKGROUND

In a warehousing system, the sorting personnel may place a package on a conveying line to convey the package to a handling robot located at a package supply platform through the conveying line, and after receiving the package, the handling robot handles the package to a corresponding destination for delivery. When the handling robot receives the package conveyed by the conveying line at the package supply platform, the package may fall, which affects the safety of package conveying.

### SUMMARY

According to a first aspect of the present disclosure, there is provided a handling method, including: firstly, determining cargo information of an object to be handled, in which the cargo information of the object to be handled includes at least one of dimension information, weight information, or shape information of the object to be handled; secondly, determining a target handling device for handling the object to be handled, in which a warehousing system includes multiple handling devices, and the multiple handling devices includes the target handling device; thirdly, determining, according to the cargo information of the object to be handled, a target motion parameter corresponding to a pick-and-place mechanism of the target handling device, in which the target motion parameter includes at least one of a motion state of the pick-and-place mechanism, a motion direction of the pick-and-place mechanism, and a number of turns of the pick-and-place mechanism; finally, controlling, according to the target motion parameter, the pick-and-place mechanism of the target handling device to receive or deliver the object to be handled.

In some embodiments, determining, according to the cargo information of the object to be handled, the target motion parameter corresponding to the pick-and-place mechanism of the target handling device includes: in a case where the cargo information of the object to be handled satisfies a preset threshold range, determining that the motion state of the pick-and-place mechanism is moving, and determining a first preset number of turns in which the pick-and-place mechanism rotates in a first direction; or in a case where the cargo information of the object to be handled does not satisfy a preset threshold range, determining that the motion state of the pick-and-place mechanism is not moving.

In some embodiments, the warehousing system further includes an output device and at least one shielding device, and the method further includes: in a case where the cargo information of the object to be handled does not satisfy the preset threshold range, controlling the output device to output prompt information, in which the prompt information is configured to instruct an operation object to set the shielding device according to a stopping position when the target handling device receives or delivers the target handling device, and the shielding device is configured to shield the object to be handled received or delivered by the target handling device to prevent the object to be handled from falling.

In some embodiments, the warehousing system further includes multiple conveying devices, and the multiple conveying devices include a target conveying device for conveying the object to be handled; and controlling, according to the target motion parameter, the pick-and-place mechanism of the target handling device to receive the object to be handled includes: controlling the target handling device to move to a receiving area corresponding to the target conveying device; and controlling, according to the target motion parameter, the pick-and-place mechanism of the target handling device to receive the object to be handled conveyed by the target conveying device.

In some embodiments, the warehousing system includes at least one shielding device, the shielding device includes a supporting part and a shielding part, and the shielding part is on the supporting part and is at a position with a preset height from a ground, in which the preset height is a fixed height or an adjustable height, and the method further includes: determining the preset height according to at least one of a height of a conveying end of the target conveying device, a height of the pick-and-place mechanism of the target handling device, or the cargo information of the object to be handled; and controlling, according to the target motion parameter, the pick-and-place mechanism of the target handling device to receive the object to be handled conveyed by the target conveying device includes: in a case where the height of the shielding part is adjusted to the preset height, controlling, according to the target motion parameter, the pick-and-place mechanism of the target handling device to receive the object to be handled conveyed by the target conveying device, and shielding, by the shielding part, the object to be handled conveyed by the conveying end of the target conveying device to prevent the object to be handled from falling.

In some embodiments, the warehousing system further includes a transferring device, the conveying device includes a conveying line, multiple conveying lines includes at least one first conveying line and at least one second conveying line, the target conveying device includes a target conveying line, the target conveying line is the first conveying line or the second conveying line, and the method further includes: after multiple objects to be handled are received by the transferring device, determining the cargo information of each object to be handled; in a case where cargo information of a first object to be handled among the multiple objects to be handled satisfies a preset threshold range, determining that a conveying line corresponding to the first object to be handled is the first conveying line; and controlling the transferring device to transfer the first object to be handled to the first conveying line, and controlling the first conveying line to convey the first object to be handled to a first conveying device located in a first receiving area corresponding to the first conveying line, in which a motion state of the pick-and-place mechanism of the first conveying device when receiving the first object to be handled is moving, and the pick-and-place mechanism rotates in a first direction by a first preset number of turns.

In some embodiments, the method further includes: in a case where cargo information of a second object to be handled among the multiple objects to be handled does not satisfy the preset threshold range, determining that a conveying line corresponding to the second object to be handled is the second conveying line; and controlling the transferring device to transfer the second object to be handled to the second conveying line, and controlling the second conveying line to convey the second object to be handled to a second conveying device located in a second receiving area of the second conveying line, in which a motion state of the pick-and-place mechanism of the second conveying device when receiving the second object to be handled is not moving, and a side of the second receiving area facing away from a conveying end of the second conveying line is provided with a shielding device.

In some embodiments, the method further includes: after a pick-and-place mechanism of a target conveying device receives the object to be handled, determining a position of the object to be handled on the pick-and-place mechanism; determining, according to the position of the object to be handled on the pick-and-place mechanism, whether the object to be handled is located within a preset area on the pick-and-place mechanism; in a case where it is determined that the object to be handled is located within the preset area on the pick-and-place mechanism, controlling the target conveying device to move the object to be handled away from a receiving area; and in a case where it is determined that the object to be handled is located outside the preset area, controlling the pick-and-place mechanism of the target conveying device to rotate a second preset number of turns in a second direction to move the object to be handled into the preset area and move the object to be handled away from the receiving area.

In some embodiments, the warehousing system further includes at least one first collecting device, and determining the position of the object to be handled on the pick-and-place mechanism includes: obtaining first detection information collected by the at least one first collecting device, in which the first collecting device includes a collecting device on the target handling device; and determining, according to the first detection information, the position of the object to be handled on the pick-and-place mechanism.

In some embodiments, in a case where it is determined that the object to be handled is located outside the preset area, controlling the pick-and-place mechanism of the target conveying device to rotate the second preset number of turns in the second direction including: in a case where the object to be handled is located outside the preset area and has not reached the preset area, controlling the pick-and-place mechanism to rotate the second preset number of turns in the second direction, in which the second direction is the same as the first direction; and in a case where the object to be handled is located outside the preset area and exceeds the preset area, controlling the pick-and-place mechanism to rotate the second preset number of turns in the second direction, in which the second direction is opposite to the first direction.

In some embodiments, the warehousing system further includes at least one second collecting device and the output device, and the method further includes: after the pick-and-place mechanism of the target handling device receives the object to be handled, controlling the target handling device to handle the object to be handled to a position of a target container corresponding to the object to be handled, and delivering the object to be handled; obtaining second detection information collected by the second collecting device, and determining, according to the second detection information, a delivery result of the object to be handled; in a case where the delivery result indicates that the object to be handled has been delivered to the target container, assigning a next handling task to the target handling device; and in a case where the delivery result indicates that the object to be handled has not been delivered to the target container, controlling the output device to output abnormality information, and suspending assignment of the next handling task to the target handling device.

In some embodiments, the target motion parameter includes the number of turns of the pick-and-place mechanism, and determining, according to the cargo information of the object to be handled, the target motion parameter corresponding to the pick-and-place mechanism of the target handling device includes: determining, according to the cargo information of the object to be handled, a cargo type of the object to be handled; and determining the number of turns of the pick-and-place mechanism of the target handling device when receiving the object to be handled according to the cargo type of the object to be handled and a mapping relationship between multiple cargo types and multiple turns.

In some embodiments, the cargo information of the object to be handled does not satisfy a preset threshold range, including: a height of the object to be handled being less than a preset height threshold, and/or a weight of the object to be handled being less than a preset weight threshold.

According to a second aspect of the present disclosure, there is provided a warehousing system, including multiple handling devices and a control device, in which the control device is configured to determine cargo information of an object to be handled, in which the cargo information of the object to be handled includes at least one of dimension information, weight information, or shape information of the object to be handled; determine a target handling device for handling the object to be handled among the multiple handling devices; determine, according to the cargo information of the object to be handled, a target motion parameter corresponding to a pick-and-place mechanism of the target handling device, and generating a handling instruction according to the target motion parameter, in which the target motion parameter includes at least one of a motion state of the pick-and-place mechanism, a motion direction of the pick-and-place mechanism, and a number of turns of the pick-and-place mechanism; and the target handling device is configured to control, according to the handling instruction, the pick-and-place mechanism to receive or deliver the object to be handled.

According to a second aspect of the present disclosure, there is provided a handling device, including: a determining module, configured to determine cargo information of an object to be handled, in which the cargo information of the object to be handled includes at least one of dimension information, weight information, or shape information of the object to be handled; determine a target handling device for handling the object to be handled, in which a warehousing system includes multiple handling devices, and the multiple handling devices includes the target handling device; determine, according to the cargo information of the object to be handled, a target motion parameter corresponding to a pick-and-place mechanism of the target handling device, in which the target motion parameter includes at least one of a motion state of the pick-and-place mechanism, a motion direction of the pick-and-place mechanism, and a number of turns of the pick-and-place mechanism; and a control module, configured to control, according to the target motion parameter, the pick-and-place mechanism of the target handling device to receive or deliver the object to be handled.

According to a fourth aspect of the present disclosure, there is provided an electronic device, including: a processor; and a memory, in which the memory is configured to store computer executable instructions; and the processor is configured to read the instructions from the memory and execute the instructions to implement the handling method according to the first aspect.

According to a fifth aspect of the present disclosure, there is provided a computer-readable storage medium having stored thereon a computer program which, when reading the instructions, implements the handling method according to the first aspect.

According to a sixth aspect of the present disclosure, there is provided a computer program product having a computer program stored on a non-transitory computer-readable storage medium, in which the computer program includes program instructions that, when executed by a computer, cause the computer to perform the handling method according to the first aspect.

According to a seventh aspect of the present disclosure, there is provided a computer program which, when executed by a processor, implements the handling method according to the first aspect.

### BRIEF DESCRIPTION OF THE DRAWINGS

In order to clearly illustrate technical solutions of embodiments of the present disclosure, a brief description of drawings used in embodiments is given below. Obviously, the drawings in the following descriptions are only part embodiments of the present disclosure, and for those skilled in the art, other drawings may be obtained according to these drawings without creative labor.

FIG. 1A is a schematic diagram illustrating a warehousing system provided in embodiments of the present disclosure.

FIG. 1B is a schematic diagram illustrating another warehousing system provided in embodiments of the present disclosure.

FIG. 2 is a schematic diagram illustrating a handling method provided in embodiments of the present disclosure.

FIG. 3 is a schematic diagram illustrating a conveying line provided in embodiments of the present disclosure.

FIG. 4 is a schematic diagram illustrating another handling method provided in embodiments of the present disclosure.

FIG. 5 is a schematic diagram illustrating a scenario in which an object to be handled is conveyed provided in embodiments of the present disclosure.

FIG. 6 is a schematic diagram illustrating another handling method provided in embodiments of the present disclosure.

FIG. 7 is a schematic diagram illustrating a scenario in which an object to be handled is on a pick-and-place mechanism provided in embodiments of the present disclosure.

FIG. 8 is a schematic diagram illustrating yet another handling method provided in embodiments of the present disclosure.

FIG. 9 is a schematic diagram illustrating a handling device provided in embodiments of the present disclosure.

FIG. 10 is a schematic diagram illustrating an electronic device provided in embodiments of the present disclosure.

### DETAILED DESCRIPTION

In order to enable those skilled in the art to better understand the technical solutions in embodiments of the present disclosure, and to make the above-described objects, features and advantages of embodiments of the present disclosure more obvious and easy to understand, the technical solutions in embodiments of the present disclosure will be described in further detail below with reference to the accompanying drawings.

In a warehousing system, sorting personnel may place packages (e.g., goods or containers with goods) on a conveying line to be conveyed through the conveying line to a handling robot located at a package supply platform. A sorting system dispatches the handling robot to move to the package supply platform corresponding to the conveying line to receive the package conveyed by the conveying line. Generally, the handling robot may control rotation of the conveying belt thereon to receive the package conveyed by the conveying line during movement to the package supply platform.

In the above-described package conveying process, in a case where an conveying object is a package of a conventional size or weight, rotation of the conveying line cooperates with rotation of a pick-and-place mechanism of a handling device to transfer the conveying object to a pick-and-place mechanism of a handling robot. However, in a case where the pick-and-place mechanism of the handling robot rotates abnormally, the conveying object may fall. Moreover, in a case where a target object has a small size (such as a small height) or a light weight, the conveying line may cause a situation where the conveying object falls due to an inertia action or the like in the process of conveying the conveying object to the handling device, and the conveying object cannot be successfully transferred to the pick-and-place mechanism of the handling robot. In a case where abnormal conditions such as the falling of the conveying object occur, the abnormal conditions need to be manually processed, such that the safety and the working efficiency of the warehousing system are influenced.

In order to solve the above problems, embodiments of the present disclosure provide a handling method, a handling device, and a warehousing system. A target motion parameter corresponding to a pick-and-place mechanism of the handling device is determined according to cargo information of an object to be handled, thereby controlling the handling device to receive or deliver the object to be handled according to the target motion parameter, avoiding a situation where the object to be handled falls, and improving safety in the conveying process and working efficiency of the warehousing system.

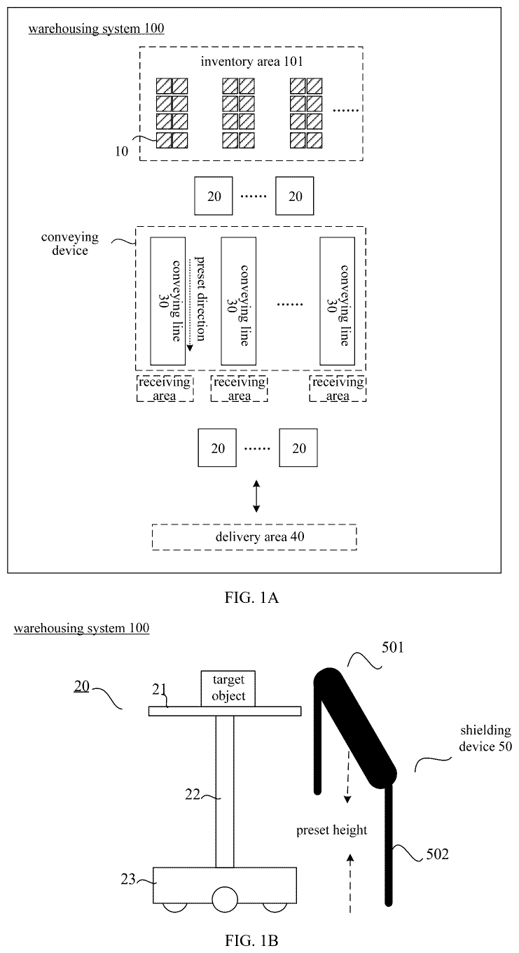

FIG. 1A is a schematic diagram illustrating a warehousing system provided in embodiments of the present disclosure. Hereinafter, the warehousing system provided in embodiments of the present disclosure will be described with reference to FIG. 1A.

As shown in FIG. 1A, the warehousing system 100 includes an inventory area 101, multiple carriers 10, multiple handling devices 20, and a control device (not shown in FIG. 1A).

In some embodiments, the inventory area 101 includes the multiple carriers 10. The carrier 10 is configured to carry a goods, a container, and the like, and may be, for example, a shelf, a pallet, a turnover, a cage car, and the like. For example, in a case where the carrier 10 is a shelf, the carrier 10 includes multiple cargo spaces (which may also be referred to as a storage slot). The cargo space may be configured to store containers such as a box, a pallet, or a packing box, or may directly place the goods, which is not limited in embodiments of the present disclosure. The following embodiments are disclosed by a case where the cargo space is configured to place the container. For example, in a case where the carrier 10 is the shelf, the shelf may be a movable shelf or a fixed shelf. The carrier 10 provided in embodiments of the present disclosure may refer to any carrier for placing the container.

In some embodiments, the handling device 20 may be configured to handle the goods, the container, or the carrier 10, and the handling device 20 may be a handling robot such as an automated guided vehicle (AGV). The handling device 20 may handle a target object to a destination corresponding to the target object. For example, the handling device 20 may handle the carrier 10 in the inventory area 101 to a workstation for picking, or the handling device 20 may handle the target object (the goods or the container) to a corresponding destination for picking or sorting operations. That is, the handling device 20 provided in embodiments of the present disclosure may be used in a sorting scenario or a picking scenario, which is not limited in embodiments of the present disclosure.

In some embodiments, in a case where the handling device 20 is used in the sorting scenario, the handling device 20 may handle the target object to a sorting platform for sorting, or the handling device 20 may handle the target object sorted to a target container for delivery.

FIG. 1B is a schematic diagram illustrating another warehousing system provided in embodiments of the present disclosure.

In some embodiments, as shown in FIG. 1B, the handling device 20 includes a pick-and-place mechanism 21, a drive mechanism (not shown in FIG. 1B), and a controller (not shown in FIG. 1B). The controller is electrically connected to a drive mechanism, and the drive mechanism is drivingly connected to the pick-and-place mechanism 21.

For example, the controller may receive a handling instruction sent by a management system, and the handling instruction is configured to instruct the handling device to receive an object to be handled and handle the object to be handled to the destination for delivery. After receiving a handling command, the controller may send a motion parameter of the handling device to the drive mechanism according to the handling command, and the drive mechanism may drive the pick-and-place mechanism to receive or deliver the object to be handled according to the motion parameter. The motion parameter is used for state information in a case where the pick-and-place mechanism receives or delivers the object to be handled, and the state information includes at least one of an operation state, a movement direction, and a number of rotation turns.

In some embodiments, the pick-and-place mechanism 21 is provided with a carrying surface for carrying the object to be handled, and the pick-and-place mechanism may be a rollover structure or a conveying structure. In a case where the pick-and-place mechanism is the rollover structure, the carrying surface may roll-over in at least one direction; and in a case where the pick-and-place mechanism is a conveying structure, the pick-and-place mechanism 21 includes at least one of a conveying belt, a conveying roller, a conveying drum, a conveying roll, or the like. For example, the pick-and-place mechanism 21 may move in at least one direction of movement to receive a target object placed thereon, or the pick-and-place mechanism 21 may move the target object placed thereon in at least one direction to deliver the target object.

It should be noted that the object that the pick-and-place mechanism 21 may carry may be the goods, a container in which the goods are placed, and the like, which is not limited in embodiments of the present disclosure.

In some embodiments, as shown in FIG. 1B, the handling device 20 further includes a base, and the pick-and-place mechanism 21 is on the base, and it may be understood that the pick-and-place mechanism 21 may be directly on the base; or the pick-and-place mechanism 21 is on the base through a support mechanism 22, and the support mechanism 22 is configured to carry the pick-and-place mechanism 21 so that the pick-and-place mechanism 21 is fixed at a height from the ground or the height from the ground is adjustable, so that the handling device 20 delivers or collects the object to be handled. In a case where the height of the support mechanism 22 is adjustable, the support mechanism 22 includes a lifting mechanism, and the lifting mechanism may be a structure capable of raising or lowering within a preset height range.

For example, the lifting mechanism includes any one of a link lifting mechanism, a gear lifting mechanism, a slide rail lifting mechanism, and the like. The link lifting mechanism may be, for example, a scissor mechanism, a four-bar link mechanism, and the like. The lifting mechanism may be powered by an electric machine, or may be powered by other power sources such as hydraulic pressure, which is not particularly limited in the present disclosure.

In some embodiments, in case that the lifting mechanism including the link lifting mechanism, the pick-and-place mechanism 21 may be carried on the lifting mechanism, for example, on a top of the lifting mechanism, and connected to the lifting mechanism. As shown in FIG. 1B, the pick-and-place mechanism 21 may be on a side of the lifting mechanism away from the ground.

For example, in a case where the support mechanism 22 is at a fixed height, the handling device 20 may move to a destination position at the fixed height to receive or deliver the target object. In a case where the support mechanism 22 is adjustable in height, that is, the support mechanism 22 includes the lifting mechanism, the lifting mechanism may lift or lower the pick-and-place mechanism 21 to different positions by itself lifting or lowering, such that the pick-and-place mechanism 21 may receive or deliver the target object at different heights.

In some embodiments, the base of the handling device 20 includes a motion mechanism 23, which may include components such as a drive wheel, a driven wheel, a motor, and the like. The motor may drive the drive wheel to rotate, such that the handling device 20 has the ability to travel. The motion mechanism 23 may also include an energy storage component such as a battery, thereby providing energy for the lifting or lowering of the lifting mechanism and the movement of the pick-and-place mechanism 21.

For example, the control device may be coupled with the handling device 20 for controlling the operation of the handling device 20. For example, the control device may control the handling device 20 to receive, handle, and deliver the target object.

In some embodiments, the control device may be a server or a terminal, or may be a device in which a warehouse management system (WMS) and a robot management system (RMS) are deployed. The terminal may include at least one of a personal computer, a notebook computer, a smartphone, a tablet computer, or a portable wearable device. The server may include an independent server or a server cluster composed of multiple servers, which is not limited in embodiments of the present disclosure.

In some embodiments, there is a communication connection between the control device and the handling device 20 for data communication. For example, the control device may be communicatively connected to the handling device 20 through a local area network (LAN), a wireless local area network (WLAN), or other networks.

In some embodiments, the control device is configured to determine cargo information of the object to be handled, in which the cargo information of the object to be handled includes at least one of dimension information, weight information, or shape information of the object to be handled; determine a target handling device for handling the object to be handled among multiple handling devices; determine, according to the cargo information of the object to be handled, a target motion parameter corresponding to a pick-and-place mechanism of the target handling device, and generate a handling instruction according to the target motion parameter, in which the target motion parameter includes at least one of a motion state of the pick-and-place mechanism, a motion direction of the pick-and-place mechanism, and a number of turns of the pick-and-place mechanism. The target handling device is configured to control the pick-and-place mechanism to receive or deliver the object to be handled according to the handling instruction.

In some embodiments, as shown in FIG. 1A, the warehousing system 100 further includes a conveying device for conveying the target object (also referred to as the object to be handled).

For example, the conveying device may be a conveying line 30 or a robot having a conveying function. The robot having the conveying function may be a three-dimensional sorting machine, a sorting robot, or the like. For example, the sorting robot may adopt a self-driving mode, move according to a preset delivery path and complete a collection or delivery operation. It should be noted that embodiments of the present disclosure is not limited to the case where the conveying device shown in FIG. 1A is the conveying line 30, and embodiments of the present disclosure does not limit a type of the conveying device, and the following embodiment will be for example described in case that the conveying device is the conveying line.

In some embodiments, the conveying line 30 may include a receiving end and a conveying end. The receiving end of the conveying line 30 may be configured to receive the target object placed by a sorting object, convey the target object to the conveying end in a preset direction, and convey the target object to the handling device 20 docked at the receiving area (also referred to as a package supply platform) corresponding to the conveying line 30 through the conveying end.

For example, the sorting object may be a sorting personnel or a sorting device. In a case where the sorting object is the sorting device, the sorting device may be the handling device 20 or another device, which is not limited in embodiments of the present disclosure. For example, as shown in FIG. 1A, the handling device 20 may handle the target object to a position of the conveying line 30 and place the target object at the receiving end of the conveying line 30 to convey the target object to the handling device 20 located in the receiving area through the conveying line 30. The handling device for conveying the target object to the conveyance line 30 and the handling device located in the receiving area for receiving the target object conveyed by the conveyance line 30 may be different handling devices of the same type.

In some embodiments, the warehousing system 100 further includes a transferring device. The transferring device is configured to receive the object to be handled and transfer the object to be handled to the receiving end of the conveying line to convey the object to be handled to a target handling device located in the receiving area through the conveying line.

In some embodiments, the transferring device may communicate with the receiving ends of the multiple conveying lines 30, and after receiving the target object placed by the sorting object, the transferring device may transfer the target object to a conveying line corresponding to the target object, and convey the target object through the conveying line.

For example, in a case where the conveying line 30 is conveying the target object, a sorting system may schedule the handling device 20 to move to the receiving area corresponding to the conveying line 30 to receive the target object conveyed by the conveying line 30. The pick-and-place mechanism of the handling device 20 may receive the target object in the receiving area according to the target motion parameter.

In some embodiments, in a case where the handling device 20 receives the target object, the pick-and-place mechanism may receive the target object by rotating a first preset number of turns in a first direction in a moving state according to the cargo information of the target object; or, the pick-and-place mechanism may receive the target object in a non-moving state.

In some embodiments, as shown in FIG. 1B, the warehousing system 100 may further include at least one shielding device 50, and a setting position of the shielding device is related to a parking position of the target handling device when receiving or delivering the object to be handled. The shielding device is configured to shield the object to be handled placed on the target handling device to prevent the object to be handled from falling.

As shown in FIG. 1B, an upstream device (such as the conveying line 30 in FIG. 1A) may deliver the target object to the handling device 20 in a preset direction, the pick-and-place mechanism 21 receives the target object delivered by the upstream device in the receiving area 33, and the shielding device 50 may be on at least one side of the handling device 20 facing away from the upstream device; or, the target object may be delivered to the handling device 20 manually in a predetermined direction, and the shielding device 50 may be on one side of the handling device 20 facing away from the delivery person along the predetermined direction.

In some embodiments, the shielding device 50 may shield the target object when the handling device 20 receives the target object. For example, in a case where the upstream device is the conveying line 30, when the target object is conveyed to the handling device 20 in the receiving area through the conveying line 30, the shielding device 50 may be on one side of the receiving area facing away from the conveying line 30, such that in a case where the handling device 20 receives the target object conveyed by the conveying line 30 in the receiving area, the shielding device 50 may shield the target object conveyed by the conveying line 30 to prevent the target object from falling to the ground.

In other embodiments, the shielding device 50 may also shield the target object when the handling device 20 delivers the target object. As shown in FIG. 1A, after receiving the target object conveyed by the conveying line 30 in the receiving area, the handling device 20 may handle the target object to a delivery area 40 to perform the delivery operation. For example, the handling device 20 may deliver the target object to a target container of the delivery area 40. In a case where the handling device 20 delivers the target object to the target container, the shielding device 50 may be on one side of the target container facing away from the handling device 20 to shield the target object delivered by the handling device 20 to prevent the target object from falling outside the target container.

In some embodiments, as shown in FIG. 1B, the shielding device 50 includes at least a shielding part 501, the shielding part 501 is on one side of the pick-and-place mechanism 21 facing away from the upstream device or the delivery person, a shielding surface of the shielding part 501 is at a preset angle (for example, 90°) with the carrying surface of the pick-and-place mechanism 21, at least a part of the shielding part 501 extends along a normal direction of the carrying surface and extends out of the carrying surface, and the shielding part 501 is configured to shield the target object delivered to prevent the target object from falling outside the target container.

For example, the shielding device 50 may further include a supporting part 502, and the shielding part 501 is on the supporting part 502 and is at a position with a preset height from a ground. The preset height is a fixed height or an adjustable height.

In some embodiments, the shielding part 501 may be fixedly on the supporting part 502, or may be adjustably on the supporting part 502, which is not limited in embodiments of the present disclosure. A setting height (that is, the preset height) of the shielding part 501 is related to at least one of a height of a conveying end of the conveying line 30, a height of the pick-and-place mechanism 21 of the handling device 20, or the cargo information of the object to be handled.

With the warehousing system according to embodiments of the present disclosure, the target motion parameter corresponding to the pick-and-place mechanism of the target handling device for handling the object to be handled is determined according to the cargo information of the object to be handled, and the pick-and-place mechanism of the target handling device is controlled to receive or deliver the object to be handled according to the target motion parameter. Since the target motion parameter of the pick-and-place mechanism is determined according to the cargo information of the object to be handled, the pick-and-place mechanism of the target handling device may receive or deliver the object to be handled with more reasonable motion parameters, thereby preventing the object to be handled from falling during the receiving or delivering process, and improving the safety of conveying and delivering of the object to be handled.

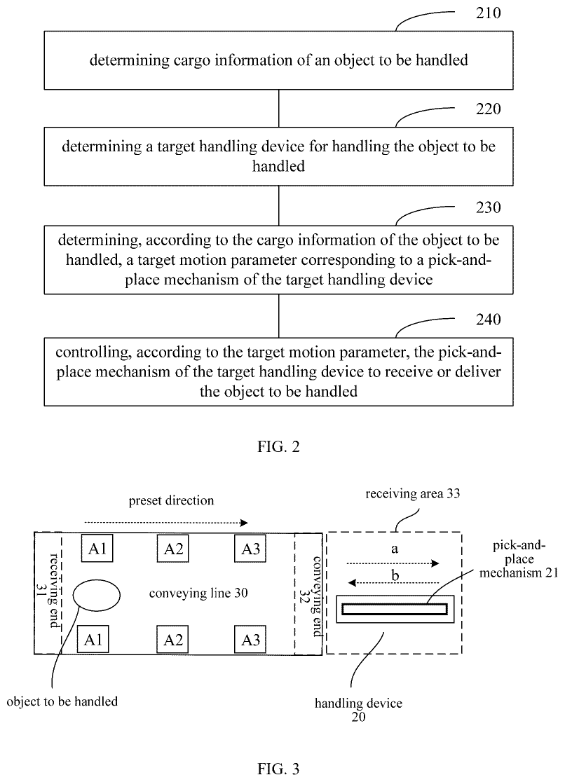

Hereinafter, a handling method according to embodiments of the present disclosure will be described with reference to FIG. 2.

FIG. 2 is a schematic diagram illustrating a handling method provided in embodiments of the present disclosure. As shown in FIG. 2, the handling method includes steps 210 to 240 as shown below. It should be noted that the handling method shown in FIG. 2 may be implemented by the warehousing system 100 in the above-described embodiment, such as by the control device in the warehousing system 100.

In step 210, determining cargo information of an object to be handled.

For example, the cargo information of the object to be handled includes at least one of dimension information, weight information, or shape information of the object to be handled. The dimension information includes information such as a length, a width, a height, a volume, a length-height ratio, or a length-width ratio of the object to be handled. The shape information of the object to be handled is configured to indicate a shape of the object to be handled, and the shape may be a conventional cuboid, cube, cylinder, other irregular shapes and the like. The weight information of the object to be handled is configured to indicate a weight magnitude of the object to be handled.

In some embodiments, the object to be handled may be a cargo or a container. For example, the object to be handled may be determined according to a task to be processed, and the task to be processed may include a sorting task, a picking task, a delivery task, and the like, which is not limited in embodiments of the present disclosure. Embodiments of the present disclosure will be described in case that the task to be processed is the sorting task.

For example, the sorting task may correspond to multiple objects to be handled, and a sorting object may place various objects to be handled onto a pick-and-place mechanism of a handling device to perform a delivery operation of the object to be handled by the handling device.

For example, the sorting object may include a sorting personnel or a sorting device. The sorting device includes at least one of the handling device (e.g. referred to as a sorting robot) or a conveying device.

For example, in a case where the sorting object is the sorting personnel, the sorting personnel may place the object to be handled onto the pick-and-place mechanism of the handling device. In a case where the sorting object is the sorting device, the sorting robot may first handle the object to be handled to a conveying device, and then convey the object to be handled to the conveying device by the handling device. The conveying device may include a conveying line.

In some embodiments, the warehousing system further includes the conveying device for conveying the object to be handled onto the pick-and-place mechanism of the handling device. For example, the conveying device may be the conveying line 30 in FIG. 1A, and the conveying device may also be a robot having a conveying function, such as a three-dimensional sorting robot and the like. A type of the conveying device is not limited in embodiments of the present disclosure. Moreover, the conveying device has been described in the above embodiments, and thus the description will not be repeated here in order to avoid repetition. The following embodiments will be illustrated in case that the conveying device is the conveying line.

For example, the conveying line includes a receiving end and a conveying end, in which the receiving end is configured to receive the object to be handled, and after receiving the object to be handled, the conveying line may convey the object to be handled to the conveying end in a preset direction. The conveying end is correspondingly provided with a receiving area, the receiving area is configured to dock the conveying device, and the conveying device receives the object to be device conveyed by the conveying end of the conveying line in the receiving area.

In some embodiments, the conveying line may be a strip-shaped conveying line, a ring-shaped conveying line, and the like, which is not limited in embodiments of the present disclosure.

For example, at least one first detection device may be on the conveying line, the first detection device is configured to collect information of the object to be handled conveyed on the conveying line, and send the collected information to the control device, and the control device determines the cargo information of the object to be handled according to the collected information. The first detection device may be an image collecting device, a sensor, or other detection device, and the like, which is not limited in embodiments of the present disclosure.

FIG. 3 is a schematic diagram illustrating a conveying line provided in embodiments of the present disclosure.

As shown in FIG. 3, a conveying line 30 includes a receiving end 31 and a conveying end 32, and one side of the conveying end 32 away from the receiving end 31 is provided with a receiving area 33, and the handling device 20 may stop at the receiving area 33, and receive an object to be handled conveyed by the conveying end 32 in the receiving area 33. The conveying line 30 conveys the object to be handled in a preset direction to convey the object to be handled onto a pick-and-place mechanism 21 of the handling device 20 located in the receiving area 33.

In some embodiments, sensors may be on both side edges of the conveying line 30, and the sensors may be configured to detect a target object of the pick-and-place mechanism for detection, in which the sensors may include optical sensors such as multiple pairs of through-beam sensors or diffuse sensors. As shown in FIG. 3, a through-beam sensor A1, a through-beam sensor A2, and a through-beam sensor A3 are on both side edges of the conveying line. In a case where the object to be handled is transferred onto the conveying line 30, the through-beam sensor A1, the through-beam sensor A2, and the through-beam sensor A3 respectively detect the object to be handled, and send detection information to a control device, which determines cargo information of the object to be handled according to collected information.

In step 220, determining a target handling device for handling the object to be handled.

In some embodiments, the target handling device is a handling device for receiving the object to be handled among multiple handling devices in a warehousing system. For example, the target handling device may be any handling device in an idle state among the multiple handling devices.

In some embodiments, in case that the target handling device receives the object to be handled conveyed by a target conveying line, the target handling device may be any one of the multiple handling devices that travels closest to a receiving area corresponding to the target conveying line and is in the idle state. For example, the control device may control the target handling device among the multiple handling devices in advance, schedule a target device to move to a receiving area corresponding to the conveying line, and wait in the receiving area to receive the object to be handled conveyed by the conveying line.

For example, the conveying line may also correspond to a queuing area, and the multiple handling devices may be parked in the queuing area. In a case where the handling devices in the receiving areas corresponding to various conveying line receive the object to be handled conveyed by the conveying line and leave the receiving area, the control device may schedule a next handling device in the queuing area to move to the receiving area, and receive a next object to be handled conveyed by the conveying line in the receiving area.

For example, multiple conveying lines may correspond to one queuing area, or some of the conveying lines among the multiple conveying lines may correspond to one queuing area, or each conveying line may correspond to one queuing area respectively, which is not limited in embodiments of the present disclosure.

In step 230, determining a target motion parameter corresponding to a pick-and-place mechanism of the target handling device according to the cargo information of the object to be handled.

For example, the target motion parameter includes at least one of a motion state of the pick-and-place mechanism, a motion direction of the pick-and-place mechanism, and a number of turns of the pick-and-place mechanism. The motion state of the pick-and-place mechanism may include movement and non-movement of the pick-and-place mechanism. In a case where the motion state of the pick-and-place mechanism is moving, the target motion parameter further includes the motion direction of the pick-and-place mechanism and/or the number of turns of the pick-and-place mechanism. It should be noted that that embodiments of the present disclosure do not specifically limit types of target motion parameters.

In some embodiments, after determining the cargo information of the object to be handled, the control device may determine the target motion parameter corresponding to the pick-and-place mechanism of the target handling device according to at least one of dimension information, weight information, or shape information in the cargo information of the object to be handled.

For example, the control device may determine the target motion parameter according to the dimension information, the weight information, or the shape information of the object to be handled; or the target motion parameter may be determined according to any two items of the dimension information, the weight information, and the shape information of the object to be handled; or the target motion parameter may be determined according to the dimension information, the weight information, and the shape information of the object to be handled, which is not limited in embodiments of the present disclosure.

In some embodiments, the above step 230 includes it is determined that the motion state of the pick-and-place mechanism is moving, and a first preset number of turns in which the pick-and-place mechanism rotates in a first direction is determined in a case where the cargo information of the object to be handled satisfies a preset threshold range; and it is determined that the motion state of the pick-and-place mechanism is not moving in a case where the cargo information of the object to be handled does not satisfy a preset threshold range.

In some embodiments, the preset threshold range may be determined according to the cargo information, and the preset threshold ranges corresponding to different cargo information may be different. For example, in a case where the cargo information is the dimension information, the preset threshold range is a dimension threshold range; in a case where the cargo information is the weight information, the preset threshold range is a weight threshold range; in a case where the cargo information is the shape information, the preset threshold range is related to the shape information.

For example, in a case where the cargo information is the dimension information, the dimension information may include a height of the object to be handled, and the following embodiments may be illustratively described in case that the dimension information of the object to be handled is the height of the object to be handled. It should be noted that the height of the object to be handled may also be referred to as a thickness of the object to be handled, that is, a dimension of the object to be handled in a vertical direction.

In some embodiments, in a case where the cargo information is the height of the object to be handled, the preset threshold range may include a height range greater than or equal to a preset height threshold. The preset height threshold may be set as needed, or the preset height threshold may be related to a setting height of a second detection device on the target handling device. For example, the preset height threshold may be greater than or equal to the setting height of the second detection device on the target handling device. The second detection device may be an image collecting device, a sensor, or other detection device, and the like, which is not in embodiments of the present disclosure.

For example, in a case where the cargo information is the weight information, the preset threshold range may include a weight range greater than or equal to the preset weight threshold. The preset weight threshold may be set as needed. For example, the preset weight threshold may be determined according to historical empirical data, which is not in embodiments of the present disclosure.

In some embodiments, the cargo information of the object to be handled failing to satisfy the preset threshold range includes at least one of the following: the height of the object to be handled is less than the preset height threshold; or the weight of the object to be handled is less than a preset weight threshold. The height of the object to be handled may be understood as a height of the object to be handled when it is delivered to the pick-and-place mechanism along a normal direction of a carrying surface.

In some embodiments, in a case where the cargo information is the height of the object to be handled, if the height of the object to be handled is greater than or equal to the preset height threshold, the cargo information of the object to be handled satisfies the preset threshold range. If the height of the object to be handled is less than the preset height threshold, the cargo information of the object to be handled does not satisfy the preset threshold range. For example, in a case where the height of the object to be handled exceeds 10 cm, the cargo information of the object to be handled satisfies the preset threshold range when the height of the object to be handled exceeds 10 cm, and in a case where the height of the object to be handled does not exceed 10 cm, the cargo information of the object to be handled does not satisfy the preset threshold range.

In other embodiments, in a case where the cargo information is the weight of the object to be handled, if the weight of the object to be handled is greater than or equal to the preset weight threshold, the cargo information of the object to be handled satisfies the preset threshold range; if the weight of the object to be handled is less than the preset weight threshold, the cargo information of the object to be handled does not satisfy the preset threshold range. For example, the preset weight threshold is 50 g. In a case where the weight of the object to be handled exceeds 50 g, the cargo information of the object to be handled satisfies the preset threshold range; in a case where the weight of the object to be handled does not exceed 50 g, the cargo information of the object to be handled does not satisfy the preset threshold range.

In still other embodiments, in a case where the cargo information is the height and weight of the object to be handled, if the height of the object to be handled is greater than or equal to the preset height threshold and/or the weight of the object to be handled is greater than or equal to the preset weight threshold, the cargo information of the object to be handled satisfies the preset threshold range; if the height of the object to be handled is less than the preset height threshold and the weight of the object to be handled is less than the preset weight threshold, the cargo information of the object to be handled does not satisfy the preset threshold range. For example, in a case where the height of the object to be handled exceeds 10 cm and the weight of the object to be handled exceeds 50 g, the cargo information of the object to be handled satisfies the preset threshold range; in a case where the height of the object to be handled does not exceed 10 cm and/or the weight of the object to be handled does not exceed 50 g, the cargo information of the object to be handled does not satisfy the preset threshold range.

For example, in a case where it is determined that the cargo information of the object to be handled satisfies the preset threshold range, it is determined that the motion state of the pick-and-place mechanism of the target handling device is moving, and a rotation direction and/or the number of turns of the pick-and-place mechanism are further determined. The rotation direction of the pick-and-place mechanism is the first direction, and the number of turns is a first preset number of turns.

In some embodiments, the pick-and-place mechanism may be a conveying structure. For example, the pick-and-place mechanism includes a conveying belt, a conveying roller, a conveying drum or a conveying roll, and the like, and the pick-and-place mechanism may rotate in at least one direction to receive or deliver the object to be handled.

With continued reference to FIG. 3, the handling device 20 includes the pick-and-place mechanism 21, which may move along a first direction a or a second direction b. The first direction a is the same as a conveying direction (i.e. a preset direction) of the conveying line 30, and the second direction b is an opposite direction to the conveying direction (i.e. the preset direction) of the conveying line 30.

In some embodiments, in a case where the cargo information of the object to be handled satisfies the preset threshold range, it is indicated that the object to be handled is large in size, heavy in weight or conventional in shape. In this case, the pick-and-place mechanism of the handling device may rotate to receive the object to be handled.

For example, as shown in FIG. 3, in a case where the pick-and-place mechanism 21 of the handling device 20 located in the receiving area 33 receives the object to be handled conveyed by the conveying line 30, the motion direction of the pick-and-place mechanism 21 is the same as the conveying direction of the conveying line 30, that is, the pick-and-place mechanism 21 may rotate in the first direction a, such that the object to be handled conveyed by the conveying line 30 to the conveying end 32 may be transferred to the pick-and-place mechanism 21 of the handling device 20 through cooperation of the rotation of the conveying line 30 and the rotation of the pick-and-place mechanism 21.

That is, in a case where the object to be handled is conveyed by the conveying line, the motion direction of the pick-and-place mechanism of the target conveying device is consistent with the conveying direction of the target conveying line.

In some embodiments, the number of turns of the pick-and-place mechanism may be preset or determined according to the cargo information of the object to be handled. For example, the pick-and-place mechanism may rotate according to a preset number of turns to receive the object to be handled. Alternatively, after determining the cargo information of the object to be handled, the control device may determine the number of turns of the pick-and-place mechanism according to the cargo information of the object to be handled.

In some embodiments, in a case where the target motion parameter is the number of turns of the pick-and-place mechanism, the above step 230 includes: a cargo type of the object to be handled is determined according to the cargo information of the object to be handled; and the number of turns of the pick-and-place mechanism of the target handling device is determined when receiving the object to be handled according to the cargo type of the object to be handled and a mapping relationship between the cargo type and the number of turns. It should be noted that whether the preset threshold range is satisfied may be determined according to the cargo information, or the cargo type of the object to be handled may be determined according to the cargo information and the preset threshold range, and the target motion parameters may be determined according to the cargo type.

In some embodiments, the cargo type of the object to be handled may be determined according to at least one of the following: the height or weight of the object to be handled. For example, according to the height and weight, several cargo types may be classified, such as a first type, a second type and a third type. For example, a cargo type of the object to be handled whose height does not exceed a first height threshold and whose weight does not exceed a first weight threshold may be determined as the first type; a cargo type of the object to be handled whose height exceeds the first height threshold and does not exceed a second height threshold, and whose weight exceeds the first weight threshold and does not exceed a second weight threshold may be determined as the second type; and a cargo type of the object to be handled whose height exceeds the second height threshold and whose weight exceeds the second weight threshold may be determined as the third type. The first height threshold is smaller than the second height threshold, and the first weight threshold is smaller than the second weight threshold.

It should be noted that the heights of the objects to be handled of the first type, the second type and the third type all exceed the preset height threshold, and the weights exceed the preset weight threshold. That is, the first type, the second type and the third type are the objects to be handled whose cargo information satisfies the preset threshold range.

For example, the control device may pre-store a first mapping relationship, which is a corresponding relationship between multiple goods types and multiple rotation turns of the pick-and-place mechanism. For example, the first mapping relationship may include a first number of turns corresponding to the first type, a second number of turns corresponding to the second type, and a third number of turns corresponding to the third type. The first number of turns is smaller than the second number of turns, and the second number of turns is smaller than the third number of turns. For example, the first number of turns may be 0.5, the second number of turns may be 0.7, the third number of turns may be 1, and the like, and the specific number of turns is not limited in embodiments of the present disclosure.

For example, in a case where the size and/or weight of the object to be handled is larger, the number of turns corresponding to the pick-and-place mechanism is larger, and in a case where the size and/or weight of the object to be handled is smaller, the number of turns corresponding to the pick-and-place mechanism is smaller.

It should be noted that the cargo type may also be classified in other ways, and the number of cargo types may be more or less. The number of turns corresponding to each cargo type may be set according to demand or determined according to historical data, which is not limited in embodiments of the present disclosure.

In some embodiments, after determining the cargo type of the object to be handled according to the cargo information of the object to be handled, the number of turns corresponding to the cargo type corresponding to the object to be handled is determined by querying a first mapping relationship, thereby determining the number of turns when the pick-and-place mechanism receives the object to be handled.

In step 240, the pick-and-place mechanism of the target handling device is controlled to receive or deliver the object to be handled according to the target motion parameter.

In some embodiments, after determining the target motion parameter, step 240 includes: the target handling device is controlled to move to a receiving area corresponding to the target conveying device; and the pick-and-place mechanism of the target handling device is controlled to receive the object to be handled conveyed by the target conveying device according to the target motion parameter.

Hereinafter, a procedure in which the pick-and-place mechanism of the target handling device receives the object to be handled will be described.

For example, in a case where the cargo information of the object to be handled satisfies the preset threshold range, the pick-and-place mechanism of the target handling device is moving when receiving the object to be handled, and rotates for the first preset number of turns in the first direction; in a case where the cargo information of the object to be handled does not satisfy the preset threshold range, the motion state of the pick-and-place mechanism of the target handling device when receiving the object to be handled is not moving, that is, the pick-and-place mechanism does not rotate.

In some embodiments, controlling the pick-and-place mechanism of the target handling device to receive the object to be handled according to the target motion parameter includes: the target handling device is controlled to move to the receiving area corresponding to the target conveying device; and the pick-and-place mechanism of the target handling device is controlled to receive the object to be handled conveyed by the target conveying device according to the target motion parameter.

The target conveying device includes the target conveying line. For example, the target conveying line is a conveying line for conveying the object to be handled among multiple conveying lines of a warehousing system. If the object to be handled is conveyed through the target conveying line, the control device may pre-schedule the target handling device to move to a receiving area corresponding to the conveying line before the target conveying line conveys the object to be handled to the conveying end.

In some embodiments, before the target handling device receives the object to be handled, an initial state of the pick-and-place mechanism may be a moving state or a non-moving state. For example, in a case where the initial state of the pick-and-place mechanism is moving, if the cargo information of the object to be handled satisfies the preset threshold range, the pick-and-place mechanism is controlled to continue to move in the first direction to receive the object to be handled; if the cargo information of the object to be handled does not satisfy the preset threshold range, the pick-and-place mechanism is controlled to stop moving. For another example, in a case where the initial state of the pick-and-place mechanism is not moving, if the cargo information of the object to be handled satisfies the preset threshold range, the pick-and-place mechanism is controlled to move in the first direction to receive the object to be handled; if the cargo information of the object to be handled does not satisfy the preset threshold range, the pick-and-place mechanism is controlled to remain in the non-moving state to receive the object to be handled.

For example, in a case where the cargo information of the object to be handled satisfies the preset threshold range, if the target motion parameter includes rotation of the pick-and-place mechanism in the first direction, after the pick-and-place mechanism receives the object to be handled, it may be determined whether the pick-and-place mechanism stops moving, that is, the number of turns of the pick-and-place mechanism may be determined according to the detection information of the second detection device on the target handling device.

In some embodiments, the second detection device on the target handling device may include multiple sensors (such as a through-beam sensor). After the pick-and-place mechanism of the target handling device rotates in the first direction and receives the object to be handled, each sensor may detect the object to be handled on the pick-and-place mechanism and its position on the pick-and-place mechanism. The control device may determine whether the pick-and-place mechanism stops moving according to detection information of each sensor.

For example, in a case where three pairs of through-beam sensors are set on the target handling device, if a first through-beam sensor detects the object to be handled, the pick-and-place mechanism will continue to move in the first direction; if a second through-beam sensor detects the object to be handled and a third through-beam sensor does not detect the object to be handled, it is indicated that the object to be handled has reached an appropriate position on the pick-and-place mechanism. In this case, the pick-and-place mechanism may be controlled to stop rotating.

In some embodiments, the warehousing system further includes a transferring device and the conveying device, in which the conveying device includes the conveying line, and multiple conveying lines include at least one first conveying line and at least one second conveying line; the target conveying device includes a target conveying line, and the target conveying line is the first conveying line or the second conveying line.

In some embodiments, in a case where the warehousing system includes the transferring device and the conveying device, the conveying device may be the conveying line. The transferring device may be communicated with receiving ends of the multiple conveying lines, and after receiving the object to be handled put by a sorting object, the transferring device may transfer the object to be handled to the target conveying line corresponding to the object to be handled, thereby conveying the object to be handled through the target conveying line. Hereinafter, in a case where the warehousing system includes the transferring device and the conveying line, a conveying process of the object to be handled will be described.

FIG. 4 is a schematic diagram illustrating another handling method provided in embodiments of the present disclosure. As shown in FIG. 4, the handling method further includes steps 410 to 450 as follows.

It should be noted that steps 410 to 450 may be performed before the above step 240, and the handling method shown in FIG. 4 will be described in case that a target handling device receives an object to be handled conveyed by a conveying line.

In step 410, cargo information of each object to be handled is determined after multiple objects to be handled are received by a transferring device.

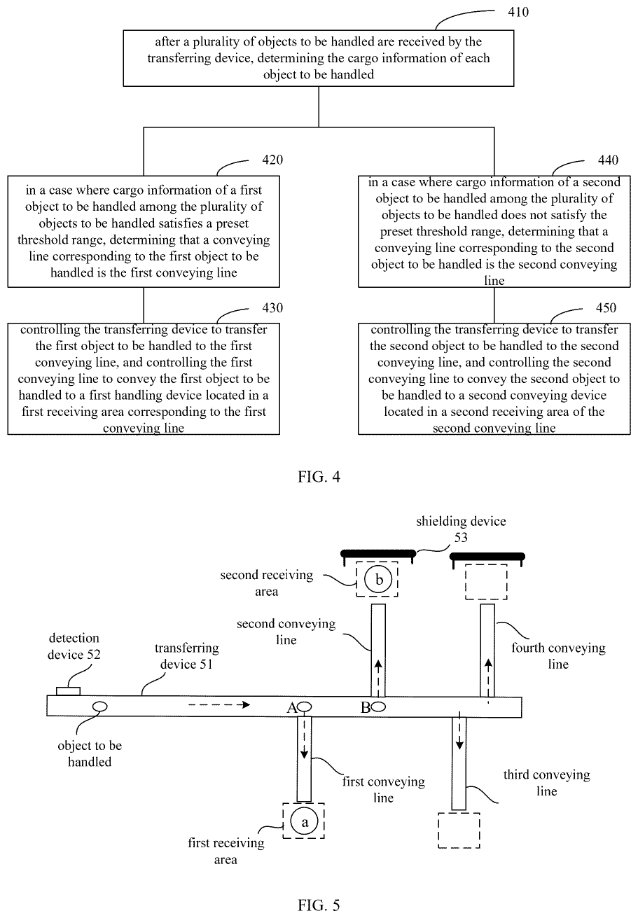

FIG. 5 is a schematic diagram illustrating a scenario in which an object to be handled is conveyed provided in embodiments of the present disclosure. As shown in FIG. 5, a warehousing system further includes a transferring device 51, which may be respectively communicated with multiple conveying lines to transfer the received objects to be handled to the conveying lines.

For example, the transferring device may communicate with receiving ends of various conveying lines to convey various objects to be handled to the receiving ends of various conveying lines, and then convey the various objects to be handled to handling devices located in receiving areas corresponding to the various conveying lines through the conveying line. The transferring device may also be in the form of a conveying belt, and sorting personnel or a sorting robot may respectively place multiple objects to be handled on the transferring device and convey them to the various conveying lines through the transferring device.

In some embodiments, the transferring device includes at least one third detection device, and the third detection device may detect the various objects to be handled placed on the transferring device to determine the cargo information of the various objects to be handled.

For example, the third detection device on the transferring device may be a scanning device, which may be identification information on the object to be handled and send a scanning result to a control device, and the control device determines the cargo information of the object to be handled according to the scanning result; or, the third detection device on the transferring device may also be an image collecting device, which may capture image information of the object to be handled and send it to the control device, and the control device may determine the cargo information of the object to be handled by processing the image information.

For example, after determining the cargo information of the various objects to be handled, the control device determines a relationship between the cargo information and a preset threshold range. That is, it is determined whether the cargo information of the various objects to be handled satisfies a preset range threshold. It should be noted that the relationship between the cargo information and the preset range threshold is explained in the above embodiments, and it is not repeated here to avoid repetition.

In some embodiments, according to the relationship between the cargo information of the various objects to be handled and the preset range threshold, multiple conveying lines in the warehousing system may be divided into two types, such as a first type of conveying lines and a second type of conveying lines. The first type of conveying lines includes at least one first conveying line among the multiple conveying lines, and the second type of conveying lines includes a second conveying line among the multiple conveying lines.

For example, the first conveying line and the second conveying line may be the same or different. That is, at least one first conveying line may be completely different from at least one second conveying line; or, at least one first conveying line may be partially the same as at least one second conveying line. That is, among the multiple conveying lines, some conveying lines may belong to both the first type of conveying lines and the second type of conveying lines, which is not limited in embodiments of the present disclosure. In some embodiments, the first conveying line is different from the second conveying line.

In step 420, in a case where cargo information of a first object to be handled among the multiple objects to be handled satisfies a preset threshold range, it is determined that a conveying line corresponding to the first object to be handled is the first conveying line.

In some embodiments, the multiple objects to be handled include the first object to be handled, and if it is determined that the cargo information of the first object to be handled satisfies the preset threshold range, the conveying line corresponding to the first object to be handled is determined to be the first conveying line. The conveying line corresponding to the first object to be handled may be any one of at least one first conveying line, or may be a first conveying line with a least workload, or may be a first conveying line determined according to an order corresponding to the first object to be handled, which is not limited in embodiments of the present disclosure.

That is, at least one first conveying line among the first type of conveying lines configured to convey the object to be handled (such as the first object to be handled) whose the cargo information satisfies the preset threshold range.

In step 430, the transferring device is controlled to transfer the first object to be handled to the first conveying line, and the first conveying line is controlled to convey the first object to be handled to a first conveying device located in a first receiving area corresponding to the first conveying line.

In some embodiments, after determining the first conveying line corresponding to the first object to be handled, the transferring device is controlled to transfer the first object to be handled to the receiving end of the first conveying line, and the first conveying line conveys the first object to be handled to a first handling device located in the first receiving area corresponding to the first conveying line after receiving the first object to be handled. The first handling device is any one of multiple handling device, and the first handling device moves to the first receiving area corresponding to the first conveying line to receive the first object to be handled conveyed by the first conveying line.

For example, since the cargo information of the first object to be handled conveyed by the first conveying line satisfies the preset range threshold, a motion state of a pick-and-place mechanism of the first handling device when receiving the first object to be handled is moving, and the pick-and-place mechanism rotates in a first direction by a first preset number of turns.

In step 440, in a case where cargo information of a second object to be handled among the multiple objects to be handled does not satisfy the preset threshold range, it is determined that a conveying line corresponding to the second object to be handled is the second conveying line.

In some embodiments, the multiple objects to be handled include the second object to be handled. In a case where it is determined that the cargo information of the second object to be handled does not satisfy the preset threshold range, it is determined that the conveying line corresponding to the second object to be handled is the second conveying line. The conveying line corresponding to the second object to be handled may be any one of at least one second conveying line, or may also be a second conveying line with a least workload, or may also be a second conveying line determined according to an order corresponding to the second object to be handled, which is not limited in embodiments of the present disclosure.

That is, at least one second conveying line in the second type of conveying lines is an object to be handled (such as a second object to be handled) whose cargo information does not satisfy the preset threshold range.

In step 450, the transferring device is controlled to transfer the second object to be handled to the second conveying line, and the second conveying line is controlled to convey the second object to be handled to a second conveying device located in a second receiving area of the second conveying line.

For example, after determining the second conveying line corresponding to the second object to be handled, the transferring device is controlled to transfer the second object to be handled to a receiving end of the second conveying line, and the second conveying line conveys the second object to be handled to the second conveying device located in the second receiving area corresponding to the second conveying line after receiving the second object to be handled. The second handling device is any one of the multiple handling device, and the second handling device moves to the second receiving area corresponding to the second conveying line to receive the second object to be handled conveyed by the second conveying line.

In some embodiments, since the cargo information of the second object to be handled conveyed by the second conveying line does not satisfy the preset range threshold, a motion state of the pick-and-place mechanism of the second conveying device when receiving the second object to be handled is not moving.

In other embodiments, since the cargo information of the second object to be handled does not satisfy the preset range threshold, it is indicated that the second object to be handled is light in weight and/or low in height. Therefore, in order to prevent the second object to be handled from falling off due to inertia when the second conveying line conveys the second object to be handled, a shielding device may be at one side of the second receiving area away from the conveying end of the second conveying line to shield the second object to be handled, thereby further ensuring the conveying process of the second object to be handled. It should be noted that the shielding device is described in detail in the following implementation.

Referring to FIG. 5, the transferring device 51 communicates with at least one conveying line, such as a first conveying line, a second conveying line, a third conveying line and a fourth conveying line. After receiving an object to be handled, the transferring device 51 detects various objects to be handled through a detection device 52 to determine cargo information of the various objects to be handled. Conveying lines corresponding to the various objects to be handled are determined according to a relationship between the cargo information of the various objects to be handled and a preset threshold range. The first conveying line and the third conveying line are a first type of conveying lines, which are configured to convey the object to be handled whose cargo information satisfies the preset threshold range, and the second conveying line and the fourth conveying line are a second type of conveying lines, which are configured to convey the object to be handled whose cargo information does not satisfy the preset threshold range.

As shown in FIG. 5, in a case where cargo information of a first object A satisfies the preset threshold range, the transferring device 51 conveys the first object A to a receiving end of the first conveying line (or the third conveying line) and conveys the first object A to a first handling device a located in a first receiving area through the first conveying line.

In a case where cargo information of a second object B does not satisfy the preset threshold range, the transferring device 51 conveys the second object B to a receiving end of the second conveying line (or the fourth conveying line) and conveys the second object B to a second handling device b located in a second receiving area through the second conveying line. One side of the second receiving area facing away from the second conveying line is provided with a shielding device 50, which may shield the second object B.

Hereinafter, a procedure in which a pick-and-place mechanism of a target handling device delivers the object to be handled will be described.

For example, in a case where the pick-and-place mechanism of the target handling device delivers the object to be handled, target motion parameters corresponding to the pick-and-place mechanism include that a motion state of the pick-and-place mechanism is moving and the pick-and-place mechanism rotates in a first direction by a first preset number of turns. The target handling device delivers the object to be handled to a target container according to the target motion parameters.

For example, in a scene where the pick-and-place mechanism of the target handling device delivers the object to be handled, the first direction is a delivery direction of the pick-and-place mechanism, that is, the first direction is a direction when the pick-and-place mechanism delivers the object to be handled to the target container. The first preset number of turns may be one turn or other turns, which is not limited in embodiments of the present disclosure.

In some embodiments, in the scene where the pick-and-place mechanism of the target handling device delivers the object to be handled, if a warehousing system includes the shielding device, the shielding device may be on one side of the target container far away from the target handling device to shield the object to be handled delivered by the target handling device and prevent the object to be handled from falling out of the target container, thereby ensuring the safety of the delivery process of the object to be handled.

With the handling method provided in embodiments of the present disclosure, the target motion parameter corresponding to the pick-and-place mechanism of the target handling device for handling the object to be handled is determined according to the cargo information of the object to be handled, and the pick-and-place mechanism of the target handling device is controlled to receive or deliver the object to be handled according to the target motion parameter. Since the target motion parameter of the pick-and-place mechanism is determined according to the cargo information of the object to be handled, the pick-and-place mechanism of the target handling device may receive or deliver the object to be handled with more reasonable motion parameters, thereby preventing the object to be handled from falling during the receiving or delivery process and improving the safety of conveying and delivering of the object to be handled.

In some embodiments, in a case where the target handling device receives the object to be handled in the receiving area, if the cargo information of the object to be handled does not satisfy the preset threshold range, for example, a weight of the object to be handled is light, the object to be handled may be conveyed to a long distance due to inertia during the process of conveying the object to be handled to the pick-and-place mechanism of the target handling device by the conveying line, thereby causing the object to be handled to fall. If the cargo information of the object to be handled satisfies the preset range, in a case where the pick-and-place mechanism of the handling device moves in the first direction to receive a package, the pick-and-place mechanism may rotate and drop the object to be handled due to abnormal rotation (for example, the number of turns is not reasonable). Therefore, in order to further improve the conveying safety of the objects to be handled and avoid the objects to be handled from falling, the warehousing system provided in embodiments of the present disclosure further includes at least one shielding device.

In some embodiments, a setting position of the shielding device is related to a docking position when the target handling device receives or delivers the object to be handled. The shielding device is configured to shield the object to be handled put on the target handling device, thereby preventing the object to be handled from falling.

In some embodiments, in the scene where the target handling device receives the object to be handled conveyed by the target conveying line, the shielding device may be at one side of the receiving area far from the conveying end of the target conveying line. In this case, the shielding device may shield the object to be handled on the pick-and-place mechanism of the target handling device conveyed by the target conveying line, thereby preventing the object to be handled from falling. That is, there is a receiving area between the shielding device and the conveying end of the target conveying line for stopping the handling device. In a case where the handling device receives the object to be handled conveyed by the conveying end of the target conveying line in the receiving area, the shielding device may shield the object to be handled to prevent the object to be handled from falling due to inertia or abnormal rotation of the pick-and-place mechanism of the handling device.

In some embodiments, the shielding device includes a supporting part and a shielding part, and the shielding part is on the supporting part and is at a position with a preset height from the ground. The preset height is a fixed height or an adjustable height.

In some embodiments, the supporting part is configured to support the shielding part, such that the shielding part is at the preset height from the ground, thereby shielding the object to be handled put on the pick-and-place mechanism of the handling device. The shielding part may be fixedly on the supporting part or may be adjustably on the supporting part. That is, a height of the supporting part may be fixed or adjustable.

For example, the shielding part may have a certain width in a vertical direction, and the width of the shielding part may be set according to the requirements, and the width of the shielding part is not limited in embodiments of the present disclosure.

In some embodiments, the handling method further includes determining a preset height according to at least one of a height of the conveying end of the target conveying device, a height of the pick-and-place mechanism of the target conveying device, or the cargo information of the object to be handled. After determining the preset height, the shielding part may be adjusted to the preset height, and the pick-and-place mechanism of the target handling device is controlled to receive the object to be handled conveyed by the target conveying device according to the target motion parameter, and the object to be handled conveyed by the conveying end of the target conveying device is shielded by the shielding part to prevent the object to be handled from falling. The target conveying device includes the target conveying line.

For example, in the scene where the target handling device receives the object to be handled conveyed by the target conveying line, the preset height of the shielding part is related to at least one of the height of the conveying end of the target conveying line, the height of the pick-and-place mechanism of the target handling device, and the cargo information of the object to be handled. The height of the conveying end of the target conveying line is a height of the conveying end of the target conveying line from the ground, and a height of the pick-and-place mechanism of the handling device is a height of the pick-and-place mechanism of the handling device from the ground.

For example, the preset height may be set corresponding to the height of the conveying end of the target conveying line, thereby ensuring that the object to be handled conveyed by the conveying end of the target conveying line may be shielded by the shielding part; or the preset height may also be set corresponding to the height of the pick-and-place mechanism of the handling device, for example, the preset height may be equal to the height of the pick-and-place mechanism, such that the object to be handled on the pick-and-place mechanism may be shielded; or the preset height may also be set according to the cargo information of the object to be handled, such as the weight and/or height of the object to be handled.

For example, in the scene where the target handling device delivers the object to be handled, the preset height of the shielding part may be related to the height of the pick-and-place mechanism of the target handling device and/or a height of the target container delivering the object to be handled.

In some embodiments, after receiving the object to be handled, the target handling device needs to deliver the object to be handled to the target container. In the process of delivering the object to be handled to the target container, the object to be handled may not be delivered to the target container due to a light weight of the object to be handled, and thus the object to be handled may fall. In this case, the shielding device may also be on one side of the target container away from the target handling device, and the shielding part of the shielding device may also shield the object to be handled delivered by the target handling device, such that the object to be handled falls into the target container.

In some embodiments, the warehousing system further includes an output device, and the handling method further includes controlling the output device to output prompt information in a case where the cargo information of the object to be handled does not satisfy the preset threshold range. The prompt information is configured to instruct an operating object to set the shielding device according to a docking position in a case where the target handling device receives or delivers the object to be handled, and the shielding device is configured to shield the object to be handled received or delivered by the target handling device to prevent the object to be handled from falling.

In some embodiments, the output device may be a display screen, an electronic label, a speaker, a projection device and the like, and the output device may output the prompt information in a form of words and/or voices. The prompt information may include setting information of the shielding device, such as a setting position of the shielding device. For example, the setting position of the shielding device is related to the docking position in a case where the target handling device receives or delivers the object to be handled.

For example, in the scene where the target handling device receives the object to be handled, the prompt information output by the output device may prompt the operating object to set the shielding device on one side of the receiving area away from the target conveying line; or, in the scene where the target handling device delivers the object to be handled, the prompt information output by the output device may prompt the operating object to set the shielding device on one side of the target container away from the target handling device.

It should be noted that the output device may be on the handling device, the conveying line, or other places, such as a workstation and the like, and the operating object may be an operator or an operating device, which is not limited in embodiments of the present disclosure.

With the handling method provided in embodiments of the present disclosure, the shielding device is configured to shield the object to be handled conveyed by the target conveying line, such that the object to be handled may fall on the pick-and-place mechanism of the handling device, thereby ensuring the safety of the conveying process of the object to be handled. The shielding device may also shield the object to be handled delivered by the handling device, such that the object to be handled may fall into the target container, thereby ensuring the safety of the delivery process of the object to be handled, avoiding the occurrence of abnormal situations caused by the object to be handled falling on the ground, and further improving the working efficiency of the warehousing system.

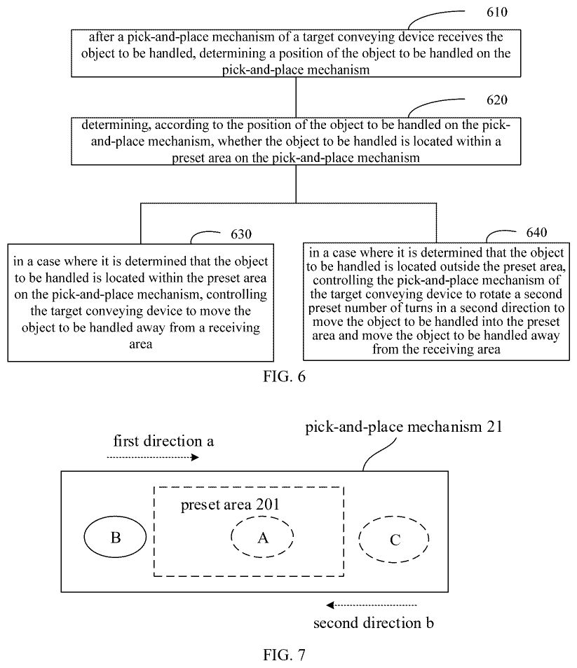

FIG. 6 is a schematic diagram illustrating another handling method provided in embodiments of the present disclosure. As shown in FIG. 6, the handling method further includes steps 610 to 640 as follows. The following steps 610 to 640 may be executed after the pick-and-place mechanism of the target handling device is controlled to receive the object to be handled in the above step 240.

In step 610, after a pick-and-place mechanism of a target handling device receives an object to be handled, a position of the object to be handled on the pick-and-place mechanism is determined.

In some embodiments, in a case where the pick-and-place mechanism of the target handling device receives the object to be handled and the pick-and-place mechanism stops rotating, the position of the object to be handled on the pick-and-place mechanism may move due to inertia, and the position of the object to be handled on the pick-and-place mechanism may affect the safety of the target handling device in handling the object to be handled.

For example, in a case where the object to be handled is near an edge on the pick-and-place mechanism, the object to be handled may fall when the target handling device is handling the object to be handled, thereby affecting the handling efficiency. Therefore, after the pick-and-place mechanism receives the object to be handled, it is needed to determine the position of the object to be handled on the pick-and-place mechanism.

In some embodiments, step 610 may include that first detection information collected by at least one first collecting device is obtained; and a position of the object to be handled on the pick-and-place mechanism is determined according to the first detection information.

In some embodiments, the first collecting device includes a collecting device (such as the second detection device in the above embodiments) on the target handling device. For example, after receiving the object to be handled, the pick-and-place mechanism of the target handling device may determine a position of the object to be handled on the pick-and-place mechanism according to the first detection information corresponding to the object to be handled collected by the first collecting device. For example, at least one collecting device may send the first detection information collected to a control device, and the control device determines the position of the object to be handled on the pick-and-place mechanism of the target handling device according to the first detection information.

For example, the first collecting device may be a sensor, an image collecting device, or other collecting devices, which is not limited in embodiments of the present disclosure. For example, in the scene where the target handling device receives the object to be handled, the first collecting device may also be at least one of a collecting device on the target conveying line (such as the above-mentioned first detection device), a collecting device on the target handling device (such as the second detection device), and a collecting device on the shielding device.

In some embodiments, in a case where the cargo information of the object to be handled satisfies the preset threshold range, the first collecting device may be multiple through-beam sensors on the target handling device; in a case where the cargo information of the object to be handled does not satisfy the preset threshold range, the first collecting device may be an image collecting device on the target handling device, or an image collecting device on the target conveying line, or an image collecting device on the shielding device and the like, which is not limited in embodiments of the present disclosure.

In step 620, it is determined whether the object to be handled is located in a preset area on the pick-and-place mechanism according to a position of the object to be handled on the pick-and-place mechanism.

In some embodiments, part of the area on the carrying surface of the pick-and-place mechanism of the handling device is divided into preset areas. For example, the preset area may be an area of a middle part on the carrying surface of the pick-and-place mechanism. After receiving the object to be handled, the pick-and-place mechanism determines a relationship between the position of the object to be handled on the pick-and-place mechanism and the preset area.

For example, in a case where the position of the object to be handled is within the preset area, it is indicated that the object to be handled has high safety during the movement of the target handling device, and usually does not fall; in a case where the position of the object to be handled is outside the preset area, it is indicated that the object to be handled has safety risks during the movement of the handling device, and the object to be handled may fall during the movement of the handling device.

FIG. 7 is a schematic diagram illustrating a scenario in which an object to be handled is on a pick-and-place mechanism provided in embodiments of the present disclosure. It should be noted that FIG. 7 is a schematic diagram illustrating a top view of a pick-and-place mechanism of a handling device.

As shown in FIG. 7, a preset area 201 is on a carrying surface of the pick-and-place mechanism 21. In a case where the pick-and-place mechanism 21 receives an object to be handled, it may be determined whether a position of the object to be handled is within the preset area 201.

In step 630, in a case where it is determined that the object to be handled is located in the preset area on the pick-and-place mechanism, the target handling device is controlled to move the object to be handled out of a receiving area.

In some embodiments, in a case where it is determined that the position of the object to be handled on the pick-and-place mechanism is within the preset area, it is indicated that the object to be handled may be safely handled by the target handling device. Therefore, the target handling device may be controlled to handle the object to be handled away from the receiving area and handle the object to be handled to a delivery destination, for example, to a position of a target container for delivery.

Continuing with reference to FIG. 7, in a case where the pick-and-place mechanism 21 receives an object A to be handled and the object A to be handled is in the preset area 201, the target handling device is directly controlled to leave the receiving area without adjusting a position of the object A to be handled.

It should be noted that a size of the object to be handled having a large size may be larger than the size of the preset area, and in this case, in a case where a center position of the object to be handled is located in the preset area, it may be said that the object to be handled is located in the preset area.

In step 640, in a case where it is determined that the object to be handled is outside the preset area, the pick-and-place mechanism of the target handling device is controlled to rotate a second preset number of turns in a second direction to move the object to be handled into the preset area and move the object to be handled away from the receiving area.

In some embodiments, in a case where it is determined that a position of the object to be handled on the pick-and-place mechanism is outside the preset area, it is indicated that there is a safety risk in the handling process of the object to be handled by the target handling device, and in order to further improve the safety of the handling process, the position of the object to be handled on the pick-and-place mechanism may be adjusted.

For example, a position adjustment process of the object to be handled may be performed simultaneously with the departure of the target handling device from the receiving area, that is, the position of the object to be handled on the pick-and-place mechanism may be adjusted during the movement of the target handling device from the receiving area; or, the position of the object to be handled on the pick-and-place mechanism may be adjusted first, and the target handling device may be controlled to leave the receiving area after the adjustment, which is not limited in embodiments of the present disclosure.

In some embodiments, in a case where it is determined that the object to be handled is located outside the preset area, the pick-and-place mechanism of the target handling device is controlled to rotate the second preset number of turns in the second direction to move the object to be handled into the preset area. The second direction is the same as the first direction, or the second direction is opposite to the first direction. The second preset number of turns may be preset, or may be determined according to the position of the object to be handled on the pick-and-place mechanism.

Referring to FIG. 7, an object B to be handled and the object C to be handled are both located outside the preset area 201. In order to ensure the safety of the movement process, it is needed to adjust positions of the object B to be handled and the object C to be handled on the pick-and-place mechanism 21.

In some embodiments, in a case where the object to be handled is located outside the preset area and has not yet reached the preset area, the pick-and-place mechanism is controlled to rotate the second preset number of turns in the second direction, in which the second direction is the same as the first direction.

In some embodiments, based on the first direction, in a case where the object to be handled does not reach the preset area in the first direction, the pick-and-place mechanism needs to continue to rotate the object to be handled by the second preset number of turns in the first direction to move the object to be handled into the preset area.

As shown in FIG. 7, since the object B to be handled does not reach the preset area 201 in the first direction, the pick-and-place mechanism 21 may be controlled to continue to rotate the second preset number of turns, such as 0.3 turns and the like, in the first direction (such as a direction a), to rotate the object B to be handled into the preset area 201.

In some embodiments, in a case where the object to be handled is located outside the preset area and exceeds the preset area, the pick-and-place mechanism is controlled to rotate the second preset number of turns in the second direction, in which the second direction is opposite to the first direction.

In some embodiments, based on the first direction, in a case where the object to be handled exceeds the preset area in the first direction, the pick-and-place mechanism needs to rotate in a direction opposite to the first direction, which may also be referred to as turning, to move the object to be handled into the preset area.

As shown in FIG. 7, the object C to be handled exceeds the preset area 201 in the first direction, and therefore, the pick-and-place mechanism 21 may be controlled to rotate the second preset number of turns, such as 0.3 turns and the like, in a direction opposite to the first direction (such as a direction b) to rotate the object C to be handled into the preset area 201.

With the handling method provided in embodiments of the present disclosure, after the pick-and-place mechanism of the target handling device receives the object to be handled, the position of the object to be handled may be further adjusted according to a relationship between the position of the object to be handled on the pick-and-place mechanism and the preset area on the pick-and-place mechanism to move the object to be handled into the preset area on the pick-and-place mechanism, thereby further improving the safety of the conveying process of the target handling device.

FIG. 8 is a schematic diagram illustrating yet another handling method provided in embodiments of the present disclosure. As shown in FIG. 8, the handling method includes steps 810 to 840 as shown below.

In step 810, after receiving an object to be handled, a pick-and-place mechanism of a target handling device controls the target handling device to handle the object to be handled to a position of the target container corresponding to the object to be handled, and delivers the object to be handled.

In some embodiments, in a scenario in which the pick-and-place mechanism of the target handling device receives the object to be handled, step 810 may be performed after step 240 described above. In a scenario in which the pick-and-place mechanism of the target handling device delivers the object to be handled, the above-described step 240 may include step 810.

For example, the pick-and-place mechanism of the target handling device may handle the object to be handled to a position of the target container and deliver the object to be handled after receiving the object to be handled conveyed by a target conveying line, or after receiving the object to be handled put by a sorting object.

In some embodiments, a warehousing system includes multiple delivery containers, each delivery container is configured to receive objects (such as goods or containers) delivered by the handling device, and the delivery container corresponding to each handling object may be determined according to an order corresponding to each handling object. A target container is one container corresponding to the object to be handled among the multiple delivery containers.

In step 820, second detection information collected by a second collecting device is obtained, and a delivery result of the object to be handled is determined according to the second detection information.

In some embodiments, the second collecting device may be a collecting device (such as the second detection device described above) on the target handling device, or a collecting device on the target container, or a collecting device on a shielding device, which is not limited in embodiments of the present disclosure. The second collecting device may collect a delivery situation of the object to be handled by the target handling device, thereby determining a delivery result of the object to be handled, and the delivery result includes delivery success and delivery failure.

In step 830, in a case where the delivery result indicates that the object to be handled has been delivered to the target container, a next handling task is assigned to the target handling device.

In some embodiments, in a case where the delivery result indicates that the object to be handled has been delivered to the target container, that is, the delivery result is successful, the target handling device may leave a delivery position of the target container and continue to execute the next handling task, that is, the target handling device may receive the next handling task assigned by a control device.

In step 840, in a case where the delivery result indicates that the object to be handled has not been delivered to the target container, an output device is controlled to output abnormality information, and assignment of the next handling task to the target handling device is suspended.

In some embodiments, in a case where the delivery result indicates that the object to be handled has not been delivered to the target container, that is, the delivery result is delivery failure, the object to be handled may still be located on the pick-and-place mechanism of the target handling device, and in this case, since the object to be handled has not been delivered successfully and may be stuck on the pick-and-place mechanism of the target handling device, the output device may be controlled to output the abnormality information to prompt the operator to perform abnormality processing on the target handling device.

In some embodiments, in a case where it is determined that the object to be handled is not delivered to the target container and is stuck on the pick-and-place mechanism, the control device may suspend the assignment of the handling task to the target handling device until the abnormality is resolved, and then continue to assign the next handling task to the target handling device.

With the handling method provided in embodiments of the present disclosure, in a process of delivering the object to be handled by the target handling device, it is determined whether the next handling task is continuously assigned to the target handling device by determining the delivery result of whether the object to be handled is delivered to the target container. In a case where the object to be handled is not delivered successfully, it is needed to output the abnormality information to instruct the operator to handle the abnormality in time, thereby improving the working efficiency of the warehousing system.

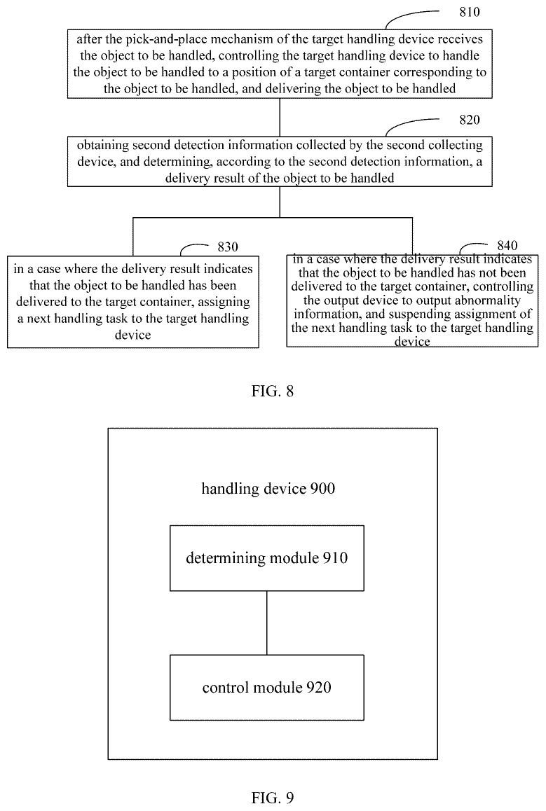

FIG. 9 is a schematic diagram illustrating a handling device provided in embodiments of the present disclosure. As shown in FIG. 9, the handling device includes a determining module 910 and a control module 920.

The determining module 910 is configured to determine cargo information of an object to be handled, in which the cargo information of the object to be handled includes at least one of dimension information, weight information, or shape information of the object to be handled; determine a target handling device for handling the object to be handled, in which a warehousing system includes multiple handling devices, and the multiple handling devices includes the target handling device; determine, according to the cargo information of the object to be handled, a target motion parameter corresponding to a pick-and-place mechanism of the target handling device, in which the target motion parameter includes at least one of a motion state of the pick-and-place mechanism, a motion direction of the pick-and-place mechanism, and a number of turns of the pick-and-place mechanism; and
the control module 920 is configured to control, according to the target motion parameter, the pick-and-place mechanism of the target handling device to receive or deliver the object to be handled.

In some embodiments, the determining module 910 is configured to, according to the cargo information of the object to be handled, determine that the motion state of the pick-and-place mechanism is moving, and determine a first preset number of turns in which the pick-and-place mechanism rotates in a first direction in a case where the cargo information of the object to be handled satisfies a preset threshold range; or determine that the motion state of the pick-and-place mechanism is not moving in a case where the cargo information of the object to be handled does not satisfy a preset threshold range.

In some embodiments, the warehousing system further includes an output device and at least one shielding device, and the control module 920 is further configured to control the output device to output prompt information in a case where the cargo information of the object to be handled does not satisfy the preset threshold range, in which the prompt information is configured to instruct an operation object to set the shielding device according to a stopping position when the target handling device receives or delivers the target handling device, and the shielding device is configured to shield the object to be handled received or delivered by the target handling device to prevent the object to be handled from falling.

In some embodiments, the warehousing system further includes multiple conveying devices, and the multiple conveying devices include a target conveying device for conveying the object to be handled. The control module 920 is further configured to control the target handling device to move to a receiving area corresponding to the target conveying device; and control, according to the target motion parameter, the pick-and-place mechanism of the target handling device to receive the object to be handled conveyed by the target conveying device.

In some embodiments, the warehousing system includes at least one shielding device, the shielding device includes a supporting part and a shielding part, and the shielding part is on the supporting part and is at a position with a preset height from a ground, in which the preset height is a fixed height or an adjustable height. The determining module 910 is further configured to determine the preset height according to at least one of a height of a conveying end of the target conveying device, a height of the pick-and-place mechanism of the target handling device, or the cargo information of the object to be handled. The control module 920 is further configured to, in a case where the height of the shielding part is adjusted to the preset height, control, according to the target motion parameter, the pick-and-place mechanism of the target handling device to receive the object to be handled conveyed by the target conveying device, and shield, by the shielding part, the object to be handled conveyed by the conveying end of the target conveying device to prevent the object to be handled from falling.

In some embodiments, the warehousing system further includes a transferring device, the conveying device includes a conveying line, multiple conveying lines includes at least one first conveying line and at least one second conveying line, the target conveying device includes a target conveying line, the target conveying line is the first conveying line or the second conveying line. The determining module 910 is further configured to determine the cargo information of each object to be handled after multiple objects to be handled are received by the transferring device; and determine that a conveying line corresponding to the first object to be handled is the first conveying line in a case where cargo information of a first object to be handled among the multiple objects to be handled satisfies a preset threshold range. The control module 920 is further configured to control the transferring device to transfer the first object to be handled to the first conveying line, and control the first conveying line to convey the first object to be handled to a first handling device located in a first receiving area corresponding to the first conveying line, in which a motion state of the pick-and-place mechanism of the first handling device when receiving the first object to be handled is moving, and the pick-and-place mechanism rotates in a first direction by a first preset number of turns.

In some embodiments, the determining module 910 is further configured to determine that a conveying line corresponding to the second object to be handled is the second conveying line in a case where cargo information of a second object to be handled among the multiple objects to be handled does not satisfy the preset threshold range. The control module 920 is further configured to control the transferring device to transfer the second object to be handled to the second conveying line, and control the second conveying line to convey the second object to be handled to a second conveying device located in a second receiving area of the second conveying line, in which a motion state of the pick-and-place mechanism of the second conveying device when receiving the second object to be handled is not moving, and a side of the second receiving area facing away from a conveying end of the second conveying line is provided with a shielding device.

In some embodiments, the determining module 910 is further configured to determine a position of the object to be handled on the pick-and-place mechanism after a pick-and-place mechanism of a target conveying device receives the object to be handled; and determine, according to the position of the object to be handled on the pick-and-place mechanism, whether the object to be handled is located within a preset area on the pick-and-place mechanism. The control module 920 is further configured to control the target conveying device to move the object to be handled away from a receiving area in a case where it is determined that the object to be handled is located within the preset area on the pick-and-place mechanism; and control the pick-and-place mechanism of the target conveying device to rotate a second preset number of turns in a second direction to move the object to be handled into the preset area and move the object to be handled away from the receiving area in a case where it is determined that the object to be handled is located outside the preset area.

In some embodiments, the warehousing system further includes at least one first collecting device. The handling device 900 further includes an obtaining module. The obtaining module is configured to obtain first detection information collected by the at least one first collecting device, in which the first collecting device includes a collecting device on the target handling device. The determining module 910 is configured to determine, according to the first detection information, the position of the object to be handled on the pick-and-place mechanism.

In some embodiments, the control module 920 is configured to control the pick-and-place mechanism to rotate the second preset number of turns in the second direction in a case where the object to be handled is located outside the preset area and has not reached the preset area, in which the second direction is the same as the first direction; and control the pick-and-place mechanism to rotate the second preset number of turns in the second direction in a case where the object to be handled is located outside the preset area and exceeds the preset area, in which the second direction is opposite to the first direction.

In some embodiments, the warehousing system further includes at least one second collecting device and the output device. The control module 920 is further configured to control the target handling device to handle the object to be handled to a position of a target container corresponding to the object to be handled, and deliver the object to be handled after the pick-and-place mechanism of the target handling device receives the object to be handled. The obtaining module is further configured to obtain second detection information collected by the second collecting device. The determining module 910 is further configured to determine, according to the second detection information, a delivery result of the object to be handled. The control module 920 is further configured to assign a next handling task to the target handling device in a case where the delivery result indicates that the object to be handled has been delivered to the target container; and control the output device to output abnormality information, and suspend assignment of the next handling task to the target handling device in a case where the delivery result indicates that the object to be handled has not been delivered to the target container.

In some embodiments, the target motion parameter includes the number of turns of the pick-and-place mechanism. The determining module 910 is configured to determine, according to the cargo information of the object to be handled, a cargo type of the object to be handled; and determine the number of turns of the pick-and-place mechanism of the target handling device when receiving the object to be handled according to the cargo type of the object to be handled and a mapping relationship between multiple cargo types and multiple turns.

In some embodiments, the cargo information of the object to be handled does not satisfy a preset threshold range, which includes: a height of the object to be handled being less than a preset height threshold, and/or a weight of the object to be handled being less than a preset weight threshold.

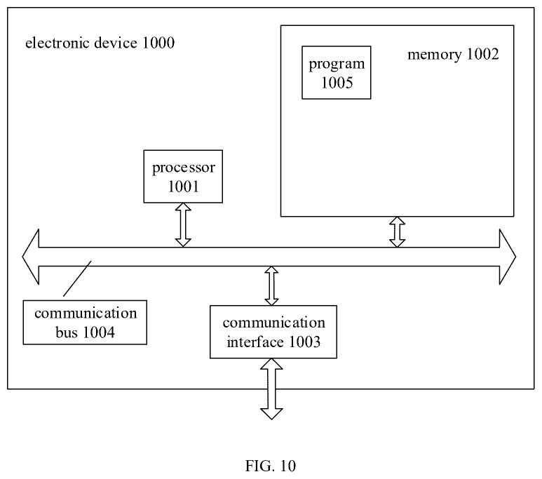

FIG. 10 is a schematic diagram illustrating an electronic device provided in embodiments of the present disclosure. In some embodiments, the electronic device includes one or more processors and a memory. The memory is configured to store one or more programs. In a case where the one or more programs are executed by the one or more processors, the one or more processors implement the handling method in the above-described embodiment.

As shown in FIG. 10, the electronic device 1000 includes a processor 1001 and a memory 1002. For example, the electronic device 1000 may further include a communication interface 1003 and a communication bus 1004.

The processor 1001, the memory 1002, and the communication interface 1003 communicate with each other through the communication bus 1004. The communication interface 1003 is configured to communicate with network elements of other devices, such as clients or other servers.

In some embodiments, the processor 1001 is configured to execute the program 1005, and specifically, the related steps in the above-described embodiment of the handling method may be executed. Specifically, the program 1005 may include program code including computer-executable instructions.

For example, the processor 1001 may be a central processing unit (CPU), or an application specific integrated circuit (ASIC), or one or more integrated circuits configured to implement embodiments of the present disclosure. One or more processors that the electronic device 1000 may include may be processors of the same type, such as one or more CPUs; may also be different types of processors, such as one or more CPUs and one or more ASICs.

In some embodiments, the memory 1002 is configured to store the program 1005. The memory 1002 may include a high-speed RAM memory, and may also include a non-volatile memory (NVM), such as at least one magnetic disk memory.

Specifically, the program 1005 may be called by the processor 1001 to cause the electronic device 1000 to execute an operation of the handling method.

Embodiments of the present disclosure provides a computer-readable storage medium storing at least one executable instruction that causes the electronic device 1000 to execute the handling method in the above embodiment when the executable instruction is executed on the electronic device 1000.

The executable instructions may be specifically configured to cause the electronic device 1000 to perform the operation of the handling method.

For example, the computer readable storage medium may be a read-only memory (ROM), a random access memory (RAM), a compact disc read-only memory (CD-ROM), a magnetic tape, a floppy disk, an optical data storage device, and the like.

In some embodiments, embodiments of the present disclosure provide a computer program product including a computer program stored on a non-transitory computer-readable storage medium, the computer program including program instructions that, when executed by a computer, cause the computer to perform the handling method described in any of the above embodiments.

In some embodiments, embodiments of the present disclosure further provide a computer program that may implement the handling method described in any of the above embodiments when the computer program is executed by a processor.

The beneficial effects that may be achieved by the handling device, the electronic device, the computer-readable storage medium, the computer program product, and the computer program provided by embodiments of the present disclosure may refer to the beneficial effects of the goods picking method provided above, and will not be repeatedly described here.

It should be noted that, in the present disclosure, relational terms such as first and second are only configured to distinguish one entity or operation from another entity or operation without necessarily requiring or implying any such actual relationship or order between these entities or operations. Moreover, terms “including”, “comprising” or any other variant thereof are intended to cover a non-exclusive inclusion, such that procedures, methods, products or devices including a series of elements not only include those elements, but also include other elements not explicitly listed, or further includes elements inherent in such procedures, methods, products, or devices. Without more restrictions, sentence “includes one . . . ” defines one element, but it is not excluded that there are additional identical elements in the procedures, methods, products, or devices that includes the element.

Each embodiment in the present specification is described in a related manner, and the same and similar parts between each embodiment may be referred to each other, and the differences between each embodiment and other embodiments will be emphasized. In particular, since the apparatus embodiment is basically similar to the method embodiment, the description is relatively simple, and reference may be made to the partial description of the method embodiment for related details.

The logic and/or step described in other manners herein or shown in the flow chart, for example, a particular sequence table of executable instructions for realizing the logical function, may be specifically achieved in any computer readable medium to be used by the instruction execution system, device or equipment (such as a system based on computers, a system including processors or other systems capable of obtaining the instruction from the instruction execution system, device and equipment and executing the instruction), or to be used in combination with the instruction execution system, device and equipment.

As to the specification, “the computer readable medium” may be any device adaptive for including, storing, communicating, propagating or transferring programs to be used by or in combination with the instruction execution system, device or equipment.

More specific embodiments (non-exhaustive list) of the computer readable medium include but are not limited to: an electronic connection (an electronic device) with one or more wires, a portable computer enclosure (a magnetic device), a random access memory (RAM), a read only memory (ROM), an erasable programmable read-only memory (EPROM or a flash memory), an optical fiber device and a portable compact disk read-only memory (CDROM).

In addition, the computer readable medium may even be a paper or other appropriate medium capable of printing programs thereon, this is because, for example, the paper or other appropriate medium may be optically scanned and then edited, decrypted or processed with other appropriate methods when necessary to obtain the programs in an electric manner, and then the programs may be stored in the computer memories. It should be understood that each part of the present disclosure may be realized by the hardware, software, firmware or their combination.

In the above embodiments, more than one steps or methods may be realized by the software or firmware stored in the memory and executed by the appropriate instruction execution system. For example, if it is realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

The above-described embodiments of the present disclosure do not limit the scope of protection of the present disclosure.

What is claimed is:

1. A handling method, comprising:
determining cargo information of a target object which is handled by a target handling device, wherein the cargo information of the target object comprises at least one of dimension information, weight information, or shape information of the target object;
determining the target handling device for handling the target object, wherein a warehousing system comprises more than one handling devices, and the more than one handling devices comprise the target handling device;
determining, according to the cargo information of the target object, a target motion parameter corresponding to a pick-and-place mechanism of the target handling device, wherein the target motion parameter comprises at least one of a motion state of the pick-and-place mechanism, a motion direction of the pick-and-place mechanism, and a number of turns of the pick-and-place mechanism; and
controlling, according to the target motion parameter, the pick-and-place mechanism of the target handling device to receive or deliver the target object.

2. The method according to claim 1, wherein determining, according to the cargo information of the target object, the target motion parameter corresponding to the pick-and-place mechanism of the target handling device comprises at least one of the following:
in a case where the cargo information of the target object satisfies a preset threshold range, determining that the motion state of the pick-and-place mechanism is moving, and determining a first preset number of turns in which the pick-and-place mechanism rotates in a first direction; and
in a case where the cargo information of the target object does not satisfy the preset threshold range, determining that the motion state of the pick-and-place mechanism is not moving.

3. The method according to claim 2, wherein the warehousing system further comprises an output device and at least one shielding device, and the method further comprises:
in a case where the cargo information of the target object does not satisfy the preset threshold range, controlling the output device to output prompt information,
wherein the prompt information is configured to instruct an operation object to set the at least one shielding device according to a stopping position when the target handling device receives or delivers the target handling device, and the at least one shielding device is configured to shield the target object received or delivered by the target handling device to prevent the target object from falling.

4. The method according to claim 1, wherein the warehousing system further comprises more than one conveying devices, and the more than one conveying devices comprise a target conveying device for conveying the target object; and
controlling, according to the target motion parameter, the pick-and-place mechanism of the target handling device to receive the target object comprises:
controlling the target handling device to move to a receiving area corresponding to the target conveying device; and
controlling, according to the target motion parameter, the pick-and-place mechanism of the target handling device to receive the target object conveyed by the target conveying device.

5. The method according to claim 4, wherein the warehousing system comprises at least one shielding device, the at least one shielding device comprises a supporting part and a shielding part, and the shielding part is on the supporting part and is at a position with a preset height from a ground, wherein the preset height is a fixed height or an adjustable height, and the method further comprises:
determining the preset height according to at least one of a height of a conveying end of the target conveying device, a height of the pick-and-place mechanism of the target handling device, or the cargo information of the target object; and
controlling, according to the target motion parameter, the pick-and-place mechanism of the target handling device to receive the target object conveyed by the target conveying device comprises:
in a case where the height of the shielding part is adjusted to the preset height, controlling, according to the target motion parameter, the pick-and-place mechanism of the target handling device to receive the target object conveyed by the target conveying device, and shielding, by the shielding part, the target object conveyed by the conveying end of the target conveying device to prevent the target object from falling.

6. The method according to claim 4, wherein the warehousing system further comprises a transferring device, each conveying device comprises a conveying line, more than one conveying lines comprises at least one first conveying line and at least one second conveying line, the target conveying device comprises a target conveying line, the target conveying line comprises the first conveying line or the second conveying line, and the method further comprises:
after more than one target objects are received by the transferring device, determining the cargo information of each target object;
in a case where cargo information of a first object to be handled among the more than one target objects satisfies a preset threshold range, determining that a conveying line corresponding to the first object is the first conveying line; and
controlling the transferring device to transfer the first object to the first conveying line, and controlling the first conveying line to convey the first object to a first handling device located in a first receiving area corresponding to the first conveying line, wherein a motion state of the pick-and-place mechanism of the first handling device when receiving the first object is moving, and the pick-and-place mechanism rotates in a first direction by a first preset number of turns.

7. The method according to claim 6, further comprising:
in a case where cargo information of a second object to be handled among the more than one target objects does not satisfy the preset threshold range, determining that a conveying line corresponding to the second object is the second conveying line; and
controlling the transferring device to transfer the second object to the second conveying line, and controlling the second conveying line to convey the second object to a second conveying device located in a second receiving area of the second conveying line, wherein a motion state of the pick-and-place mechanism of the second conveying device when receiving the second object is not moving, and a side of the second receiving area facing away from a conveying end of the second conveying line is provided with a shielding device.

8. The method according to claim 2, further comprising:
after a pick-and-place mechanism of a target conveying device receives the target object, determining a position of the target object on the pick-and-place mechanism;
determining, according to the position of the target object on the pick-and-place mechanism, whether the target object is located within a preset area on the pick-and-place mechanism;
in a case where it is determined that the target object is located within the preset area on the pick-and-place mechanism, controlling the target conveying device to move the target object away from a receiving area; and
in a case where it is determined that the target object is located outside the preset area, controlling the pick-and-place mechanism of the target conveying device to rotate a second preset number of turns in a second direction to move the target object into the preset area and move the target object away from the receiving area.

9. The method according to claim 8, wherein the warehousing system further comprises at least one first collecting device, and determining the position of the target object on the pick-and-place mechanism comprises:
obtaining first detection information collected by the at least one first collecting device, wherein each first collecting device comprises a collecting device on the target handling device; and
determining, according to the first detection information, the position of the target object on the pick-and-place mechanism.

10. The method according to claim 8, wherein in a case where it is determined that the target object is located outside the preset area, controlling the pick-and-place mechanism of the target conveying device to rotate the second preset number of turns in the second direction comprising at least one of the following:
in a case where the target object is located outside the preset area and has not reached the preset area, controlling the pick-and-place mechanism to rotate the second preset number of turns in the second direction, wherein the second direction is the same as the first direction; and
in a case where the target object is located outside the preset area and exceeds the preset area, controlling the pick-and-place mechanism to rotate the second preset number of turns in the second direction, wherein the second direction is opposite to the first direction.

11. The method according to claim 1, wherein the warehousing system further comprises at least one second collecting device and an output device, and the method further comprises:
after the pick-and-place mechanism of the target handling device receives the target object, controlling the target handling device to handle the target object to a position of a target container corresponding to the target object, and delivering the target object;
obtaining second detection information collected by the at least one second collecting device, and determining, according to the second detection information, a delivery result of the target object;
in a case where the delivery result indicates that the target object has been delivered to the target container, assigning a next handling task to the target handling device; and
in a case where the delivery result indicates that the target object has not been delivered to the target container, controlling the output device to output abnormality information, and suspending assignment of the next handling task to the target handling device.

12. The method according to claim 1, wherein the target motion parameter comprises the number of turns of the pick-and-place mechanism, and determining, according to the cargo information of the target object, the target motion parameter corresponding to the pick-and-place mechanism of the target handling device comprises:
determining, according to the cargo information of the target object, a cargo type of the target object; and
determining the number of turns of the pick-and-place mechanism of the target handling device when receiving the target object according to the cargo type of the target object and a mapping relationship between more than one cargo type of the object and more than one turn of the pick-and-place mechanism.

13. The method according to claim 2, wherein the cargo information of the target object does not satisfy the preset threshold range, which comprises at least one of the following:
a height of the target object being less than a preset height threshold, or a weight of the target object being less than a preset weight threshold.

14. A warehousing system, comprising more than one handling devices and a control device, wherein:
the control device is configured to:
determine cargo information of a target object to be handled, wherein the cargo information of the target object comprises at least one of dimension information, weight information, or shape information of the target object;
determine a target handling device for handling the target object among the more than one handling devices; and
determine, according to the cargo information of the target object, a target motion parameter corresponding to a pick-and-place mechanism of the target handling device, and generating a handling instruction according to the target motion parameter, wherein the target motion parameter comprises at least one of a motion state of the pick-and-place mechanism, a motion direction of the pick-and-place mechanism, and a number of turns of the pick-and-place mechanism; and
the target handling device is configured to control, according to the handling instruction, the pick-and-place mechanism to receive or deliver the target object.

15. The warehousing system according to claim 14, further comprising at least one shielding device;
wherein a setting position of the at least one shielding device is related to a parking position of the target handling device when receiving or delivering the target object; and the at least one shielding device is configured to shield the target object placed on the target handling device to prevent the target object from falling.

16. The warehousing system according to claim 15, wherein the warehousing system further comprises more than one conveying devices, and the more than one conveying devices comprise a target conveying device for conveying the target object; and
the at least one shielding device is on one side of a conveying end of the target conveying device, and a receiving area for docking the conveying device is between the shielding device and the conveying end of the target conveying device; and the shielding device is configured to shield the target object conveyed by the conveying end of the target conveying device to prevent the target object from falling.

17. The warehousing system according to claim 16, wherein each shielding device comprises a supporting part and a shielding part;
the shielding part is on the supporting part and is at a position with a preset height from a ground, and the shielding part is configured to shield the target object conveyed by the conveying end of the target conveying device; and
the preset height is a fixed height or an adjustable height; the preset height is related to at least one of a height of the conveying end of the target conveying device, a height of the pick-and-place mechanism of the target conveying device, or the cargo information of the target object.

18. The warehousing system according to claim 16, wherein the warehousing system further comprises at least one first collecting device, the at least one first collecting device comprises at least one collecting device of a collecting device on the target handling device, a collecting device on the target conveying device, or a collecting device on the at least one shielding device; and
the first collecting device is configured to collect first detection information, and the first detection information is configured to indicate a position of the target object on the pick-and-place mechanism.

19. The warehousing system according to claim 16, wherein the warehousing system further comprises a transferring device, the conveying device comprises a conveying line, the target conveying device comprises a target conveying line, and the transferring device is configured to:
receive the target object and transfer the target object to a receiving end of the target conveying line to convey the target object to the target conveying device located in the receiving area through the target conveying line.

20. An electronic device, comprising:
one or more processors; and
a memory, configured to store one or more programs, which, when executed by the one or more processors, cause the electronic device to:
determine cargo information of a target object to be handled, wherein the cargo information of the target object comprises at least one of dimension information, weight information, or shape information of the target object;
determine a target handling device for handling the target object, wherein a warehousing system comprises more than one handling devices, and the more than one handling devices comprise the target handling device;
determine, according to the cargo information of the target object, a target motion parameter corresponding to a pick-and-place mechanism of the target handling device, wherein the target motion parameter comprises at least one of a motion state of the pick-and-place mechanism, a motion direction of the pick-and-place mechanism, and a number of turns of the pick-and-place mechanism; and
control, according to the target motion parameter, the pick-and-place mechanism of the target handling device to receive or deliver the target object.
